(19) United States
(12) Patent Application Publication
(10) Pub. No.: US 2026/0257478 A1
(43) Pub. Date: Sep. 3, 2026

(54) PATTERNED PRINT HEADS AND RESISTIVE ANODES FOR ELECTRODEPOSITION THICKNESS DISTRIBUTION CONTROL

(71) Applicant: Lam Research Corporation, Fremont, CA (US)

(72) Inventors: Steven T. Mayer, Aurora, OR (US); Kari Thorkelsson, Portland, OR (US)

(21) Appl. No.: 19/164,558

(22) PCT Filed: Apr. 4, 2024
(86) PCT No.: PCT/US2024/023048

§ 371 Date: Sep. 11, 2025

Related U.S. Application Data
(60) Provisional application No. 63/495,086, filed on Apr. 8, 2023.

(51) Int. Cl. B41J 2/16; B41J 2/14; C25D 7/00

(52) U.S. Cl. CPC B41J 2/1601; B41J 2/14072; B41J 2/14129; B41J 2/1643; C25D 7/00; B41J 2002/14491

(57) ABSTRACT

Metal may be electroplated on a semiconductor substrate in an electroplating chamber with a micro inert anode array positioned proximate to the semiconductor substrate having one or more die. The micro inert anode array includes a plurality of micro inert anode elements that are independently controllable. Current applied to the micro inert anode elements provides a current distribution in the array that may be based at least in part on a die layout in the semiconductor substrate or based at least in part on global within-wafer corrections. The current distribution may achieve uniform plating thickness even with a non-uniform distribution of features in the die of the semiconductor substrate. In some implementations, current distribution may be adjusted in the array during substrate rotation according to a rotational path of the semiconductor substrate

### INCORPORATION BY REFERENCE

A PCT Request Form is filed concurrently with this specification as part of the present application. Each application that the present application claims benefit of or priority to as identified in the concurrently filed PCT Request Form is incorporated by reference herein in its entirety and for all purposes.

### FIELD

Implementations herein relate to methods and apparatuses for electroplating metal on a semiconductor wafer. More particularly, the methods and apparatuses described herein relate to electroplating metal on die layouts of semiconductor wafers.

### BACKGROUND

In semiconductor device manufacturing, a conductive material, such as copper, is often deposited by electroplating onto a seed layer of metal to fill one or more recessed features on a semiconductor wafer. Electroplating is a method of choice for depositing metal into the vias and trenches of the wafer during damascene processing and is also used in through-resist plating in wafer level packaging (WLP) applications to form pillars and lines of metal. Another application of electroplating is filling through-silicon vias (TSVs), which are relatively large vertical electrical connections used in 3D integrated circuits and 3D packages.

In some electroplating processes, a conductive seed layer covers the entire surface of the substrate prior to electroplating (typically in damascene and TSV processing) and electroplating of metal occurs over the entirety of the substrate. The electroplating may be conducted in a manner that favors deposition of fully seed-metalized surface into recesses. This is sometimes referred to as bottom-up fill. In other electroplating processes, a portion of the seed layer is covered by a non-conducting mask material, such as by photoresist, while another portion of the seed layer is exposed. In substrates with a partially masked seed layer, electroplating occurs only on the exposed portions of the seed layer while the covered portions of the seed layer are protected from being plated upon. Electroplating on a substrate having a seed layer that is coated with patterned mask material (e.g., photoresist) is referred to as mask plating and is typically used in WLP applications.

Fabrication of semiconductor devices commonly involves a series of steps for forming fine line interconnects and other metallic features. For example, in 3D packaging, WLP applications may involve forming a conductive seed layer on the semiconductor substrate, forming a layer of photoresist on the conductive seed layer, and exposing and developing the layer of photoresist to define a pattern therein, where the pattern typically repeats over a certain size scale and shape and may be referred to as a “die.” After metallization operations, the semiconductor wafer is typically sliced (“diced”) into functionally identical entities (referred to as “dies”) before undergoing further packaging operations involving other semiconductor wafers and die.

Lines, pads, and pillars are typically plated to create bonds between substrates and to create interconnecting electrical connections within and between die of differing functions. It is generally desirable for electroplating to produce acceptable within-die (WID), within-wafer (WIW), and within-feature (WIF) plating non-uniformity.

The background provided herein is for the purposes of generally presenting the context of the disclosure. Work of the presently named inventors, to the extent that it is described in this background or presented as contextual information in the description, that may not otherwise qualify as prior art at the time of filing, is neither expressly nor impliedly admitted as prior art against the present disclosure.

### SUMMARY

Aspects of this disclosure pertain to print heads that may be characterized by the following features: (a) a template layer comprising a non-conductive material having recesses or openings defining a pattern of conductive material to be printed on a substrate; (b) a conductive layer overlaying the pattern of conductive material; and (c) a resistive intermediate layer disposed between the template layer and the conductive layer. In certain embodiments, the template layer contacts the resistive intermediate layer, and the resistive intermediate layer contacts the conductive layer.

In certain embodiments, the resistive layer has a conductivity of about 10⁻⁵ to 10⁻⁷ S/cm. In certain embodiments, the resistive layer has a thickness of no greater than about 0.1 times the smallest pitch of the pattern of conductive material to be printed on a substrate. In certain embodiments, the resistive layer has a thickness of about 0.1 to 10 micrometers. In certain embodiments, the resistive layer comprises a carbon film.

In certain embodiments, the conductive layer has a sheet resistance of at most about 0.1 ohm/square. In certain embodiments, the conductive layer has a thickness of about 0.01 to 10 micrometers. In certain embodiments, the conductive layer comprises copper, nickel, cobalt, titanium, or any combination thereof.

In certain embodiments, the non-conductive material of the template layer comprises a glass, a polymer, a ceramic, or any combination thereof.

In certain embodiments, the recesses or openings in the template layer have a thickness of about 5 to 300 micrometers. In certain embodiments, the pattern of conductive material to be printed on the substrate comprises a WLP pattern. In some cases, the WLP pattern is an RDL pattern. In some cases, the WLP pattern is a pillar pattern.

In some embodiments, the print head includes an electrically conductive contact to the conductive layer for applying an electrical potential from a power supply to the conductive layer. In some cases, the electrically conductive contact contacts a peripheral portion of the conductive layer. As an example, the electrically conductive contact may electrically contact the peripheral portion of the conductive layer at multiple points and is configured to provide substantially uniform current distribution around the peripheral portion of the conductive layer.

Aspects of this disclosure pertain to methods of printing features on substrate. Such methods may be characterized by the following operations: (I) electroplating a metal into recesses of a print head, wherein the print head comprises (a) a template layer comprising a non-conductive material having the recesses or openings defining a pattern of the features to be printed on a substrate, (b) a conductive layer overlaying substantially the entire region of recesses or openings; and (c) a resistive intermediate layer disposed between the template layer and the conductive layer; and (II) electroplating the metal from the recesses of the print head template onto the substrate to print the features on the substrate.

In certain embodiments, electroplating the metal into the recesses of the print head comprises applying a cathodic electrical potential to the conductive layer, relative to a counter electrode. In certain embodiments, electroplating the metal into the recesses of the print head comprises electroplating the metal from a secondary electrode, which serves as the counter electrode. In certain embodiments, electroplating the metal into the recesses of the print head comprises electroplating the metal onto exposed portions of the resistive intermediate layer.

In certain embodiments, electroplating the metal into the recesses of the print head comprises flowing an electrolyte across the surface of the template layer.

In certain embodiments, electroplating the metal from the recesses of the print head template onto the substrate comprises applying an anodic electrical potential to the conductive layer, relative to the substrate.

In certain embodiments, electroplating the metal from the recesses of the print head template onto the substrate comprises contacting the template layer with the substrate without contacting the metal electroplated into the recesses of the print head template with the substrate.

In certain embodiments, a method further comprises electroplating a second metal into the recesses of the print head thereby creating a layer of the metal and a layer of the second metal within the recesses of the print head. In some implementations, electroplating the metal from the recesses of the print head template onto the substrate is performed after electroplating the second metal into the recesses of the print head. In some implementations, electroplating the metal from the recesses of the print head template onto the substrate prints a stack of the metal and the second metal on the substrate.

Some aspects of this disclosure pertain to electroplating platforms that may be characterized by the following features: (I) a print head comprising recessed features defining a pattern to be printed a substrate; (II) a chamber comprising (i) a support configured to hold the substrate, and (ii) a support configured to hold a secondary anode; and (III) a controller configured to cause: (i) electroplating a metal from the secondary anode into the recessed features of the print head, and (ii) electroplating the metal from the recessed features of the print head onto the substrate.

In certain embodiments, the print head comprises: (a) a template layer comprising a non-conductive material having recesses or openings defining the pattern of conductive material to be printed on a substrate, (b) a conductive layer overlaying substantially the entire pattern of conductive material; and (c) a resistive intermediate layer disposed between the template layer and the conductive layer.

In certain embodiments, the resistive layer has a conductivity of about 10⁻⁵ to 10⁻⁷ S/cm. In certain embodiments, the resistive layer has a thickness of no greater than about 0.1 the smallest pitch of the pattern of conductive material to be printed on a substrate.

In certain embodiments, the conductive layer comprises copper, nickel, cobalt, titanium, or any combination thereof.

In certain embodiments, the non-conductive material of the template layer comprises a glass, a polymer, a ceramic, or any combination thereof.

In certain embodiments, the pattern of conductive material to be printed on the substrate comprises a WLP pattern.

In certain embodiments, during electroplating a metal from the secondary anode into the recessed features of the print head, the secondary anode is disposed about the periphery of the print head. In certain embodiments, the secondary anode is substantially planar, and, during electroplating a metal from the secondary anode into the recessed features of the print head, the secondary anode aligned substantially parallel to and facing the recessed features of the print head.

In certain embodiments, the controller is further configured to cause (i) providing a first gap between the print head and the substrate while electroplating the metal from the secondary anode into the recessed features of the print head, and (ii) providing a second gap between the print head and the substrate while electroplating the metal from the recessed features of the print head onto the substrate, wherein the second gap is smaller than the first gap. In certain embodiments, the print head contacts the substrate while electroplating the metal from the recessed features of the print head onto the substrate.

In certain embodiments, the chamber is configured to induce convection over the print head recessed features while electroplating the metal from the secondary anode into the recessed features of the print head. In certain embodiments, the chamber is configured to flow electrolyte substantially parallel to a surface of the print head while electroplating the metal from the secondary anode into the recessed features of the print head. In certain embodiments, the chamber is configured to rotate the print head while electroplating the metal from the secondary anode into the recessed features of the print head.

Some aspects of this disclosure pertain to methods of fabricating a print head. Such methods may be characterized by the following operations: (I) forming a conductive layer having a substantially uniform thickness of a conductive material; (II) forming resistive intermediate layer over the conductive layer, wherein the resistive intermediate layer has a substantially uniform thickness of a resistive material; and (III) forming a template layer on the resistive intermediate layer, wherein the template layer comprises a non-conductive material having recesses or openings defining a pattern of conductive material to be printed on a substrate.

In certain embodiments, forming the template layer comprises: (a) electroplating a metal pattern into recesses of a patterned photoresist; (b) removing the photoresist from the around the metal pattern; (c) coating the metal pattern with a layer of dielectric; and (d) removing raised metal features to form the template layer.

In certain embodiments, the resistive layer has a conductivity of about 10⁻⁵ to 10⁻⁷ S/cm. In some cases, the resistive layer has a thickness of no greater than about 0.1 the smallest pitch of the pattern of conductive material to be printed on a substrate. In certain embodiments, the resistive layer comprises a carbon film.

In certain embodiments, the conductive layer comprises copper, nickel, cobalt, titanium, or any combination thereof.

In certain embodiments, the non-conductive material of the template layer comprises a glass, a polymer, a ceramic, or any combination thereof.

In certain embodiments, the pattern of conductive material to be printed on the substrate comprises a WLP pattern.

In certain embodiments, forming the template layer comprises: (a) depositing a conductive seed layer on the resistive intermediate layer; (b) applying and patterning a photoresist on the seed layer; (c) electroplating metal into recesses of the photoresist; (d) removing the photoresist from the seed layer; (e) etching away the conductive seed layer in regions where the metal was not electroplated and thereby producing isolated raised metal features; (f) coating the raised metal features with a layer of dielectric; (g) planarizing the layer of dielectric to expose the raised metal features; and (h) removing raised metal features to form the template layer.

Some aspects of this disclosure pertain to patterned electrically resistive anodes that may be characterized by the following features: (a) a template layer comprising a non-conductive material having recesses or openings defining a pattern of conductive material to be printed on a substrate, (b) a plurality of micro anodes in the recesses or openings of the template layer; (c) a conductive layer overlaying the pattern of conductive material; and (d) a resistive intermediate layer disposed between the template layer and the conductive layer.

In certain embodiments, the micro anodes have largest width or diameter of about 5 to 200 μm. In certain embodiments, the micro anodes comprise titanium, tantalum, tungsten, niobium, platinum, gold, iridium, or a combination of any of these.

In certain embodiments, the template layer has a thickness of about 5 μm or less.

In certain embodiments, the resistive layer has a thickness of no greater than about 0.1 times the smallest pitch of the pattern of conductive material to be printed on a substrate. In certain embodiments, the resistive layer has a thickness of about 0.1 to 10 micrometers.

In certain embodiments, the conductive layer has a sheet resistance of at most about 0.1 ohm/square. In certain embodiments, the pattern of conductive material to be printed on the substrate comprises a WLP pattern.

Some aspects of this disclosure pertain to methods of depositing features on substrate. Such methods may be characterized by the following operations: (I) in an electroplating cell, receiving the substrate with a mask layer on its surface, wherein the mask layer comprises recesses corresponding to a pattern of features to be electrodeposited on the substrate; and (II) electroplating a metal into the recesses of the mask layer by controlling a patterned electrically resistive anode comprising (a) a template layer comprising a non-conductive material and micro-anodes corresponding to the pattern of the features to be electrodeposited on the substrate, (b) a conductive layer overlaying the template layer; and (c) a resistive layer disposed between the template layer and the conductive layer.

In certain embodiments, electroplating the metal into the recesses of the mask layer comprises applying anodic current and/or anodic potential, relative to the substrate, to the patterned electrically resistive anode in the electroplating cell.

In certain embodiments, during electroplating the metal into the recesses of the mask layer, the patterned electrically resistive anode and the substrate are separated by a gap of about 0.1 and 2 millimeters.

In certain embodiments, the template layer has a thickness of about 5 micrometers or less.

In certain embodiments, the micro-anodes comprise titanium, tantalum, tungsten, niobium, platinum, gold, iridium, or a combination of any of these.

Some aspects of this disclosure to pertain to electroplating platforms that may be characterized by the following features: (I) an electroplating cell comprising a support configured to hold a substrate, and (II) a patterned electrically resistive anode comprising micro-anodes corresponding to a pattern of features to be deposited on the substrate; and (III) a controller configured to cause: (i) receiving in the electroplating cell the substrate with a mask layer on its surface, wherein the mask layer comprises recesses corresponding to the pattern of features to be deposited on the substrate; and (ii) electroplating a metal into the recesses of the mask layer by controlling a patterned electrically resistive anode.

In certain embodiments, the patterned electrically resistive anode comprises (a) a template layer comprising a non-conductive material and the micro-anodes corresponding to the pattern of the features to be deposited on a substrate, (b) a conductive layer overlaying the template layer; and (c) a resistive layer disposed between the template layer and the conductive layer

In certain embodiments, the resistive layer has a conductivity of about 10⁻⁵ to 10⁻⁷ S/cm. In certain embodiments, the resistive layer has a thickness of no greater than about 0.1 the smallest pitch of the pattern of conductive material to be deposited on a substrate.

In certain embodiments, the micro-anodes comprise titanium, tantalum, tungsten, niobium, platinum, gold, iridium, or a combination of any of these.

In certain embodiments, the non-conductive material of the template layer comprises a glass, a polymer, a ceramic, or any combination thereof. In certain embodiments, the template layer has a thickness of about 5 micrometers or less.

In certain embodiments, the pattern of conductive material to be deposited on the substrate comprises a WLP pattern.

In certain embodiments, electroplating the metal into the recesses of the mask layer comprises applying anodic current and/or anodic potential, relative to the substrate, to the patterned electrically resistive anode in the electroplating cell. In certain embodiments, the controller is further configured to cause providing a gap between the patterned electrically resistive anode and the substrate while electroplating the metal into the recesses of the mask layer, wherein the gap is about 0.1 and 2 millimeters.

In certain embodiments, the electroplating cell is configured to flow electrolyte substantially parallel to a surface of the patterned electrically resistive anode while electroplating the metal into the recesses of the mask layer.

These and other features of the disclosure will be presented in more detail below, sometimes with reference to the associated drawings.

### BRIEF DESCRIPTION OF THE DRAWINGS

FIG. 1A is a flow diagram of an example method of electroplating patterned metal features on a substrate.

FIG. 1B schematically illustrates a cross-section of a template feature during a two-stage metal pattern printing procedure.

FIG. 2A is flow chart illustrating a two-stage procedure for printing a multi-layer metal stack in accordance with a first embodiment.

FIG. 2B schematically illustrates a cross-section of a template feature during printing of the multi-layer metal stack in accordance with the first embodiment.

FIG. 3 is flow chart illustrating a two-stage procedure for printing a multi-layer metal stack in accordance with a second embodiment.

FIG. 4A schematically illustrates a cross-section of a print head in accordance with certain embodiments.

FIG. 4B schematically illustrates a print head with an electrical bus contacting the periphery of a conductive layer in the print head.

FIG. 5 schematically illustrates a sequence of operations for fabricating a print head in accordance with certain embodiments.

FIGS. 6A and 6B illustrate schematic diagrams of flow direction of electrolyte and its impact on plating within a patterned feature.

FIGS. 7A and 7B illustrate two embodiments of patterned electrically resistive anode configured to electroplate features through a mask on a substrate.

FIG. 7C illustrates a patterned electrically resistive anode in use during electroplating features through a mask on a substrate.

FIG. 8A illustrates a schematic diagram of an example of a print head electroplating cell in combination with general electroplating cell fluidic and plating controls according to some implementations.

FIG. 8B depicts a simplified view of a multi-tool electroplating apparatus according to some implementations.

FIG. 9 depicts a simplified view of an example electroplating apparatus with different electroplating cells and modules according to some implementations.

### DETAILED DESCRIPTION

In this disclosure, the terms “semiconductor wafer,” “wafer,” “substrate,” “wafer substrate,” and “partially fabricated integrated circuit” are used interchangeably. One of ordinary skill in the art would understand that the term “partially fabricated integrated circuit” can refer to a silicon wafer during any of many stages of integrated circuit fabrication thereon. A wafer or substrate used in the semiconductor device industry typically has a diameter of 200 mm, or 300 mm, or 450 mm. The following detailed description assumes the embodiments are implemented on a wafer. However, the embodiments are not so limited. The work piece may be of various shapes, sizes, and materials. In addition to semiconductor wafers, other work pieces that may take advantage of the disclosed embodiments include various articles such as glass panels, printed circuit boards, magnetic recording media, magnetic recording sensors, mirrors, optical elements, micro-mechanical devices, partially fabricated display devices, and the like. Work pieces in the disclosed embodiments may include substrates with seed layers and masked surfaces, which can include semiconductor wafers, printed circuit boards, panels, and the like.

In this disclosure, the terms “electrolyte,” “plating bath,” “bath,” and “plating solution” are used interchangeably.

In this disclosure, the term “printing” refers to a process of forming raised features on a nominally flat substrate. The printed features may form a pattern of raised features on such substrate. The printed features may occupy a relatively small fraction of the substrate surface area (e.g., about 50% or about 20% or less). In certain embodiments, printing is performed by electroplating metal from recesses in a template onto a substrate.

In this disclosure, the term “print head” refers to a device that can provide metal or other printable material on a substrate. In some implementations, a print head temporarily holds printable material, and, in a later operation, it releases such material to deposit a pattern of the material on the substrate; A print head may have a template comprising a pattern of recesses in that correspond to a pattern to be printed on a substrate.

When referring to a pattern or other physical attribute of a substrate, a print head, a resistive anode, or similar structure, the terminology “corresponding to” includes both the exact same structure of the pattern or other physical attribute and related variants of such structure. For example, a physical process such as electroplating may employ a template pattern that is related to but different from the pattern to be electroplated onto a substrate using the template. This is because the physical characteristics of electroplating, such as current distribution, mass transport, and kinetics, cause some variation during transfer of the pattern on the template to the deposited pattern on the substrate.

In the following description, numerous specific details are set forth in order to provide a thorough understanding of the presented embodiments. The disclosed embodiments may be practiced without some or all these specific details. In other instances, well-known process operations have not been described in detail to not unnecessarily obscure the disclosed embodiments. While the disclosed embodiments will be described in conjunction with the specific embodiments, it will be understood that it is not intended to limit the disclosed embodiments.

### Introduction and Overview

Aspects of this disclosure pertain to forming raised features on substrate. Such features may be conductive such as metal features such as those employed in packaging for integrated circuits. In some implementations, the features are formed by photoresist-free patterning using electrochemical deposition in a manner that prints the features on the substrate.

Conventionally, patterning of copper interconnects at the packaging scale of integration (i.e., about 1 to 100 micrometer features) is performed using through resist plating processes. Conventional patterning requires an extensive sequence of processes to create and pattern photoresist, electrodeposit metal in features of the photoresist, and finally remove the photoresist. The unit operations may include spin on coating, baking, lithographic patterning, descum/ashing, and photoresist stripping. Each of these operations may require its own specialized tool or hardware. Certain embodiments of the disclosure eliminate some or all these operations. Further, conventional through resist plating processes suffer from an inherent inability to plate uniformly over the scale of a die due to variability in the density of features and the associated variability of electrolytic resistivity among the various regions on the substrate, and over the entire wafer due to the larger electrical resistance of a seed layer on the substrate from the periphery to the center.

Various electroplating technologies such as high resistance virtual anodes and organic electroplating additives are employed to compensate for these effects, but ever more challenging patterns and specifications sometimes render these exiting techniques inadequate.

In various embodiments, a pattern of conductive features is printed using a two-operation process. In a first operation, a print head containing a pattern of features—which may match the physical layout of wiring for an integrated circuit—is electroplated to fill recessed features or “recesses” with a conductive material such as a metal or alloy. This is followed by a second operation, which transfers the conductive material to the substrate. In this second operation, the print head may touch or come into close proximity to the surface of the substrate on which printing occurs. In this second operation, the conductive material previously electroplated into the print head recesses serves as an anode. The second operation may be conducted in a manner such that the conductive material is directly electroplated from the print head onto the substrate to produce a printed pattern dictated by the pattern of recesses (the template) in the print head.

The first operation may be conducted in a manner that electroplates substantially the same amount of conductive material in each recess or region of the print head. Thus, the first operation may address potential non-uniformity due to loading effects (feature density variations) and/or the terminal effect (reduced electrical potential in the center region of the substrate due to ohmic losses as current travels from the substrate periphery, where electrical contact to a power source is made, to the substrate center, where no external electrical contact exists).

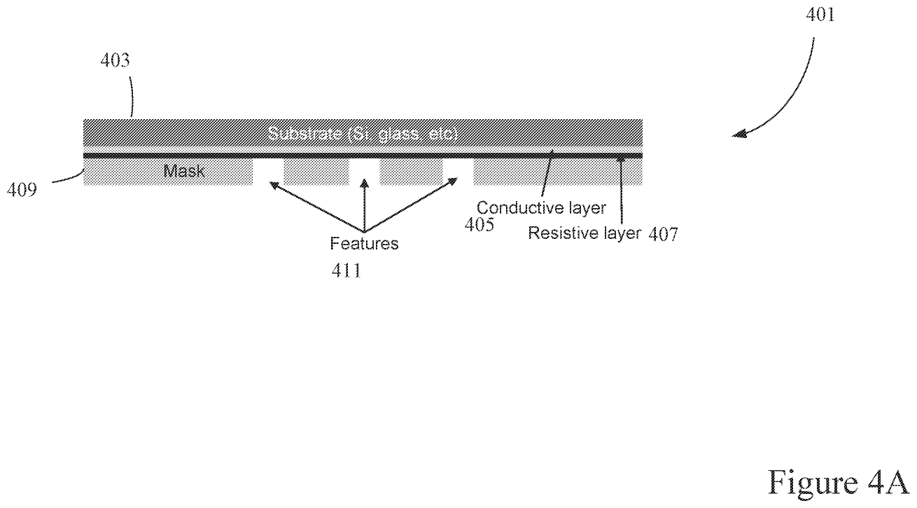

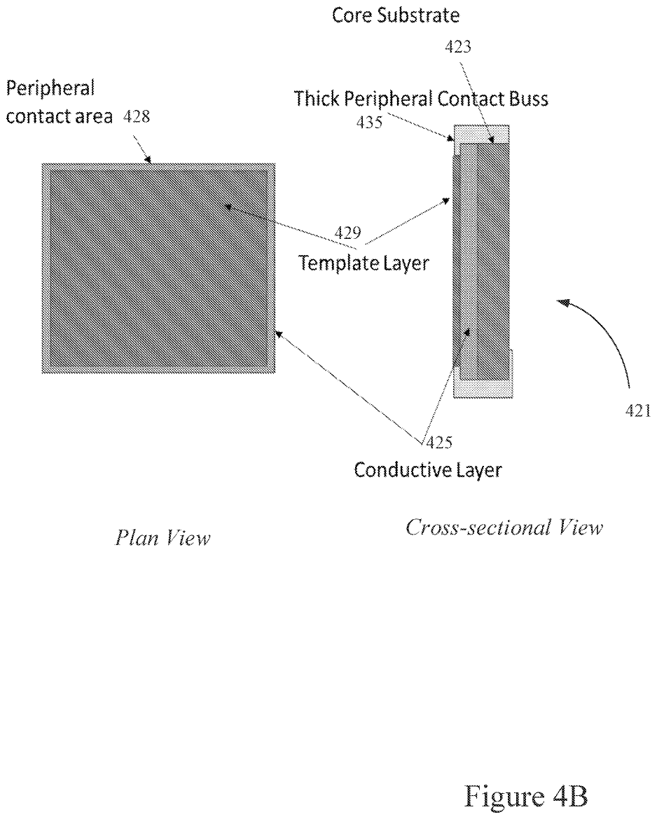

Desired electroplating uniformity may be accomplished by employing a print head having a layered structure of the films underlying the patterned template of recesses. In some embodiments, the layered structure may comprise, in this order: (a) a conductive metal underlayer, (b) a resistive intermediate layer, and (c) the template containing recesses defining the pattern to be printed. See e.g., FIG. 4A. In some embodiments, the conductive layer is sufficiently thick and of a large enough specific conductance that applying power to the conductive layer at the periphery of the print head (via electrical leads) produces only a small lateral voltage drop and minimal terminal effect. In some embodiments, the contact to the conductive layer is made to the back plane at multiple points (or over a large surface), thereby exhibiting, at most, a minimal terminal effect. In some embodiments, the thickness of the intermediate layer is at most about 0.1 times smallest pitch or critical dimension of the pattern to be printed. During the first operation, the resistive intermediate layer may “swamp” the electroplating solution phase resistance distribution and variations induced by feature loading and/or the terminal effect.

After filling the recesses of the print head in the first operation, the print head may be brought into close proximity to, or even contact with, the substrate. During this operation, a conductive electrolytic solution present within the recesses contacts both the metal electroplated during the first operation and substrate. After the print head and the substrate have been appropriately aligned, the substrate is negatively polarized (as a cathode), whereupon the conductive material in the print head feature is transferred to the substrate (printed).

In certain embodiments, the entire template of the print head experiences an electric field powered by a single conductive surface or electrode, which may be the conductive metal underlayer (a). This conductive surface/electrode may cover the entire area occupied by the template. This design can be distinguished from print head designs employing independently addressable electrodes configured to selectively power discrete regions or features of the print head, with some features turned on and others off for any printing operation. In embodiments employing only a single conductive surface/electrode the template pattern may be customized for a particular application, e.g., a specific RDL pattern or pillar pattern.

Note that the two operations imply that the printing operation—the second operation—is performed with a consumable anode (the metal or other conductive material that fills the print head recesses during the first operation). This metal is “consumed” in the operation of transferring it to the product substrate. This approach is distinguishable from approaches employing one or more inert anodes in a print head during the printing operation.

The approaches disclosed herein may be part of a pattern forming process that eliminates repetitive photoresist processing sequences. Further, the print head and associated hardware are amenable to scale up to large sizes (e.g., 500×500 mm panels and larger), which are increasingly difficult to process uniformly with existing technology, patterning, and electroplating approaches.

Process of Printing onto a Substrate

As suggested, printing onto a substrate may include a recess filling phase and a printing phase. In the recess filling phase, metal is electroplated into recesses of a print head containing a pattern of features. In the printing phase, the metal previously electroplated into the recesses is electroplated onto a substrate. The metal now printed on the substrate has a pattern mirroring or otherwise related to the pattern of a recessed features on a print head. Both phases can have many variations, some of which are explained herein.

Certain two-phase printing processes may be generally characterized by the following operations: (I) electroplating a metal into recesses of a print head; and (II) electroplating the metal from the recesses of the print head template onto the substrate to print the features on the substrate. The print head includes (a) a template layer comprising a non-conductive material having the recesses or openings defining a pattern of the features to be printed on a substrate, (b) a conductive layer overlaying substantially the entire region of recesses or openings; and (c) a resistive intermediate layer disposed between the template layer and the conductive layer. In some embodiments, the print head substrate and the conductive layers are combined (forming a solid working part that can be manipulated, and which, during operation, carries electricity to the resistive layer). The print head may have regions of the resistive intermediate layer exposed at the bases of the recesses. As such, the metal electroplated in operation (I) may be electroplated directly onto the exposed regions of the resistive layer.

The first operation (electroplating the metal into the recesses of the print head) may involve applying a cathodic electrical potential to the conductive layer, relative to a counter electrode, while the second operation (electroplating the metal from the recesses of the print head template onto the substrate) may involve applying an anodic electrical potential to the conductive layer, relative to the product substrate. In certain embodiments, in the first operation, the counter electrode may be a consumable anode (e.g., made from the metal being electroplated), or it may be an inert anode. In certain embodiments, the second operation (electroplating the metal from the recesses of the print head template onto the substrate) may involve contacting the template layer with the product substrate without contacting the metal electroplated into the recesses of the print head template with the substrate.

The metal may be any metal that can be printed by electroplating onto a substrate. Examples include those metals commonly used in fabricating conductive lines, pillars, pads, contacts, and other structures in electronic devices. Such metals may include materials electroplatable from aqueous media, such as copper, nickel, tin, silver, cobalt, gold, cadmium, iron, palladium, indium, lead, as well as materials electroplatable only from other solvents, media or as molten salts, and alloys or mixtures of any of these.

Electroplating during the first operation (recess filling) may involve positioning of the print head in an electroplating apparatus such that electrical contact is made to the conductive layer at the periphery of and/or the back of the print head. For the first phase, the electroplating apparatus houses a secondary anode and an electrolyte that contains ions of a metal intended to be used for electroplating. The print head is cathodically biased and immersed into an electrolyte solution, which provides metal ions that are reduced in the recesses of the print head, as described in the following equation, where M is a metal (e.g., copper), and n is the number of electrons transferred during the reduction:

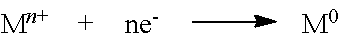

Because the electrolyte solution experiences the most cathodic potentials only at the exposed bottom portions of the recessed features of the template layer (other portions of the electrode are masked with an insulator and do not have a physical or electrical connection to the conductive and resistive layers), electrochemical deposition, e.g., as facilitated by a through-mask electroplating process, occurs only within the recessed features, and not on the field, e.g., a top surface of the template. Thus, electroplating may be used to at least partially fill recesses in the template with metal.

The first operation may be conducted in a manner that electroplates substantially the same amount of conductive material in each feature of the print head. Thus, the first operation may address potential non-uniformity due to loading effects (feature density variations within dies) and/or the terminal effect (reduced electrical potential in the center region of the substrate due to ohmic losses as current travels from the substrate periphery, where electrical contact to a power source is made, to the substrate center, where no external electrical contact exists).

The electroplating uniformity may be accomplished by employing a print head having a resistive layer between the template recesses (or openings) and a conductive layer that applies a cathodic potential to the print head. During the first operation, the resistive intermediate layer may “swamp” the resistance variations created by feature loading and/or the terminal effect. This approach may allow deposition of metal into the print head recesses to occur in a highly uniform pattern (e.g., thickness of each isolated plated feature being very nearly identical) on both a shorter range “die” scale and a longer-range full product substrate global (e.g., panel or wafer) scale. A Further explanation of this resistance swamping effected and its control on current distribution is provided elsewhere herein.

The print head, a secondary electrode, and an electrolyte therebetween define an electroplating cell during the first operation. The print head serves as a cathode and the secondary electrode serves as an anode. The metal electroplated into recesses of the print head comes directly from the electrolyte. In some embodiments, the secondary electrode comprises this same metal as that to be electroplated. In other embodiments, the secondary electrode does not comprise the metal. For example, the secondary electrode may be an inert electrode that facilitates an oxidation reaction of a component of the electrolyte, such as, e.g., water, or ferrous ion if present.

The secondary electrode is generally not a substrate on which the metal is printed in the second operation but in some implementations can be one and the same. If present during the first operation, metal would be removed from the substrate substantially uniformly during the first operation but not be completely removed (because the metal film on the substrate is required to allow deposition to the substrate in the second operation), or more commonly, the substrate may not participate in the electrochemical reaction (e.g., by being in the electrolyte, but not being energized).

In certain embodiments, the electrolyte used during the first operation has a composition characterized as follows: cupric ion from, e.g., sulphate (metal ion source) in a concentration of about 10 to 80 g/L or about 20-65 g/L, and sulfuric acid in a concentration of about 5 to 120 g/L of about 20 to 100 g/L. The electrolyte optionally includes one or more additives such as an accelerator, a suppressor, and optionally a leveler that promote bottom-up fill. As an example, such additives may include 50 ppm chloride ion (suppressor adsorption linkage), 10 ppm 2,3-dimercapto-1 propanesulfonic acid (surface brightener and accelerator), 1000 ppm polyethylene glycol 10,000 MW (suppressor). In some embodiments, commercial copper plating organic additives of the three common classes (accelerator, suppressor/carrier, and leveler) can be used with their well-established purposes and functions. However, in printing with print heads according to this disclosure, it may be possible to eliminate the use of leveler additive, because it can serve to compensate for spatial plating non-uniformities and loading effects associated with the non-uniform density of features. In certain embodiments, the resistive layer of the print head serves that same purpose but in a different way (electrical compensation versus electrochemical surface reaction kinetics).

From a process design perspective, a high resistance electrolyte leads to a larger dimensionless ratio of the resistive film to the resistance of the electrolyte in the gap between the print head and the workpiece (Rf/Rg), as well as a larger ratio of surface kinetic resistance to the resistance of the electrolyte in the gap between the anode and the workpiece (Rs/Rg). Higher values of Rf/Rg and Rs/Rg tend to have better feature distribution uniformities. From an electrochemistry perspective, the Rs/Rg may be understood in terms of a Wagner number and the desire to have a high surface resistance that can overwhelm electrolyte-distributed-resistance effects. Analogously, for a fixed Rf, higher bath conductivity creates a more dominant impact of the resistive film's resistance, making the current more constant between isolated to dense area anode features. But from a practical deposition and productivity rate, feature morphology perspective, there is a balance and limitation to choosing the highest conductive electrolyte composition. Generally, hydrogen ion mobility is higher than copper ion mobility, so, the conductivity of acid/copper solutions are highest at very high acid and very low copper concentrations. But the rate of a copper plating process will be mass transport limited at too low a copper concentration. Therefore, a balance between sufficient copper in the solution to meet process rate and feature morphology requirements and the desire to have a high conductivity solution to feature thickness distribution considerations must be made. So, a wide range of solution composition may be chosen, depending on the balance of these needs. The concentrations are bounded by the solubility limit of a solution, as generally predicted by the chemical solubility product rules of two cations in a solution of a shared anion.

Generally, for copper electroplating applications, the electrolyte contains copper ions from a copper salt such as copper sulfate, copper methane sulfonate, copper pyrophosphate, copper propane sulfonate, etc. The electrolyte may include an acid increasing the electrolyte conductivity. Example acids include but are not limited to sulfuric acid, phosphoric acid, and methane sulfonic acid. In some embodiments, the electrolyte includes plating additives. Plating additives modify the surface reaction kinetics and often are useful in improving the current distribution (feature shape and thickness distribution) relative to that which occurs in their absence (improved relative to the primary or electrolyte-resistance-driven current distribution).

Regarding electroplating additives, an accelerator may include an alkane chain with at least one mercapto- and one sulfonic acid group or acid-salt. For example, the accelerator may include mercaptopropane sulfonic acid or mercaptoethane sulfonic acid. In some embodiments, the suppressor may include derivatives of polyethylene- and polypropylene-glycols and oxides. In these or other cases, the suppressor may include at least one material selected from the group consisting of: polyethylene oxide, polypropylene oxide, polyethylene glycol, polypropylene glycol, polyethylene with at least one S- and/or N-containing functional group, and polypropylene oxide with at least one S- and/or N-containing functional group. Other electroplating additives may include carriers and/or ductilizers. The composition of additives in the electrolyte may be optimized for use with a print head in an electroplating process.

In certain embodiments, during the first operation, the electrolyte is maintained at a temperature of about 15 to 45° C.

In certain embodiments, the template surface is separated from a substantially parallel surface of another element in the electroplating cell by a gap of about 100 and 100 micrometers. The volume defined by the gap contains electrolyte during the first operation. In some embodiments, the other element (opposite the template surface) is a substrate on which metal is printed in the second operation. In some embodiments, the other element is an inert element such as a high resistance virtual anode or a solid inert material. During the first operation, the other element may be unconnected from an electrical power source or load. During the first operation, the other element may not participate in an electrochemical reaction. In certain embodiments, the other element is the secondary electrode, which does participate in the electrochemical reaction that electroplates metal into the template recesses.

In certain embodiments, during the first operation, the electrolyte exhibits convection. This may facilitate uniform electroplating rates over the full extent of the template surface and/or facilitate smooth or regular plating into the recessed features of the template. Convention may have any of various possible patterns. For example, (a) convection may be accomplished by rotation of the template in an electroplating cell, (b) a reciprocating paddle in front of the template, (c) flow across or against the template surface (in a direction substantially parallel to the template surface), or (d) any combination of these effects. In some embodiments, electrolyte flows across the surface of the template, in a direction approximately perpendicular to the direction of the recesses in the template layer. Such flow is sometimes referred to herein as shearing or “cross-flow,” and apparatus for producing cross-flow are described elsewhere herein. Generally, the apparatus and method of delivering cross flow to the surface of the print head having recessed features can lead to a spatially uniform time average intensity of flow shear above all features. This allows the convective eddy and the mass transfer of ions plating within the feature to have equal access to the feature and have a more uniformly electroplated feature surface and shape, and/or composition (e.g., when plating an alloy).

In certain embodiments, the secondary electrode used during the first operation is disposed about the periphery of the print head. In certain embodiments, the secondary electrode used during the first operation is substantially planar, and, during electroplating a metal from the secondary anode into the recessed features of the print head, the secondary anode aligned substantially parallel to and facing the recessed features of the print head.

As indicated, the second operation (printing) electroplates metal from the recesses of the print head onto the substrate surface. During this operation, the print head may be brought into proximity, or even in uniform contact, with the substrate. In certain embodiments, the print head touches and conforms to the substrate's surface. To avoid a short circuit, however, the metal in the recesses of the print head does not contact the substrate surface.

A conductive electrolytic solution is present within the recesses, contacting both the metal electroplated during the first operation and substrate. Thus, an electroplating cell is formed by the print head—or more precisely the metal in the recesses, which serves as an anode—the substrate, which serves as a cathode, and an electrolyte therebetween.

After the print head and the substrate have been appropriately aligned, the substrate is negatively polarized (as a cathode), where upon the metal in the print head features is transferred to the substrate (printed).

In certain embodiments, both operations (recess filling and printing to a substrate) are performed in the same electroplating chamber. In some examples, the substrate is present in the electroplating chamber during both operations. The substrate may be mounted in a chuck. In certain embodiments, the first operation is performed with the print head and the substrate being separated by a first gap and the second operation is performed with the print head and the substrate being separated by a second gap, which smaller than the first gap. As an example, the first gap may be about 200 micrometers or greater and the second gap may be about 1 micrometer or less (e.g., the substrate and the print head may actually contact one another). In other embodiments, the two operations are performed in different electroplating chambers.

In certain embodiments, during the second operation, the print head and substrate are separated from one another by a gap of no more than about 1 micrometer. In certain embodiments, the print head and substrate contact one another during the second operation. During the contact, unrecessed regions of the template layer may engage with the substrate surface and the electrolyte is substantially confined to the recessed regions.

In certain embodiments, prior to or during the second operation, the print head and the product substrate may be aligned with each other. In some embodiments, alignment is accomplished by having at least one the print head or substrate element configured to flex and move, such as though actuators and piezoelectric device capable of actively moving the two parts in three or more axis relative to each another, combined with, or alternatively, having a set of self-aligning elements including gimbles, and/or elastic underlying material elements such as a rubber film (allowing the part to bend and confirm to the other surface). Free motion on a global and local scale can be with just one of, or both the printer head and substrate.

In certain embodiments, during the second operation, the electrolyte is quiescent or flows only at a very low rate compared to the flow rate employed during the first operation.

In certain embodiments, the electrolyte used during the second operation has a composition including an acid and the ions of the metal to be deposited. The composition may be based in part on considerations described above for the electrolyte used the first operation. However, in embodiments in which the substrate does not have a mask, the electrolyte need not include some or any additives that promote bottom-up fill. In certain embodiments, the second operation includes 70 g/L copper sulfate and 5 g/L sulfuric acid. For example, the electrolyte may contain copper ions from a copper salt such as copper sulfate, copper methane sulfonate, copper pyrophosphate, copper propane sulfonate, etc. The electrolyte may include an acid increasing the electrolyte conductivity. Example acids include but are not limited to sulfuric acid, phosphoric acid, and methane sulfonic acid. In some embodiments, the electrolyte includes plating additives. Unlike in conventional electroplating processes, plating performed according to this operation does not inherently need plating additives to modify and control the thickness distribution of the printed bumps or lines. But they may be added to control the surface finish (smooth bright films when desired) and/or control to a designed grain structure, or chemical impurity of the deposit.

In certain embodiments, during the second operation, the electrolyte is maintained at a temperature of about 15 to 45° C.

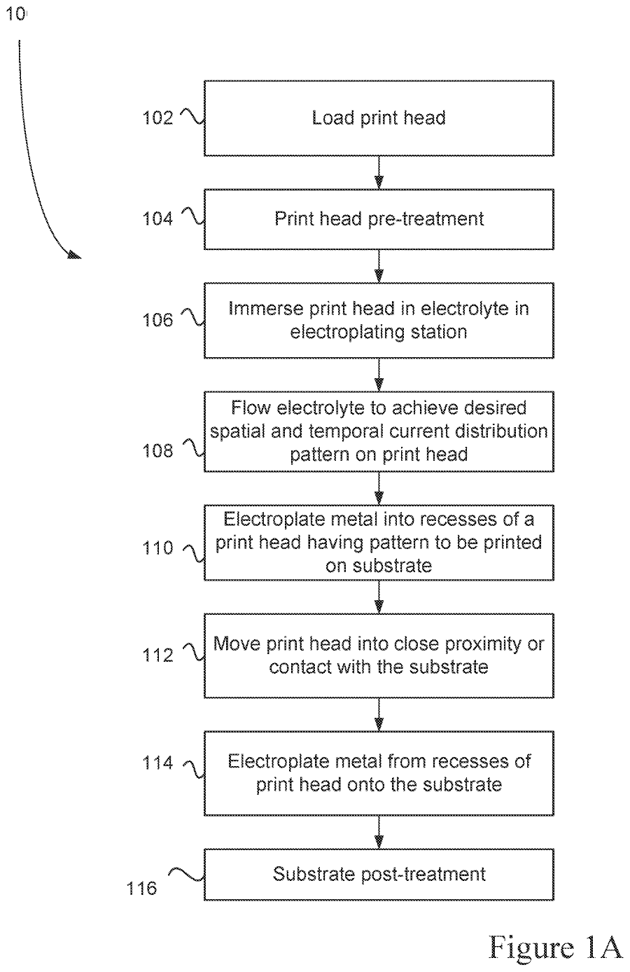

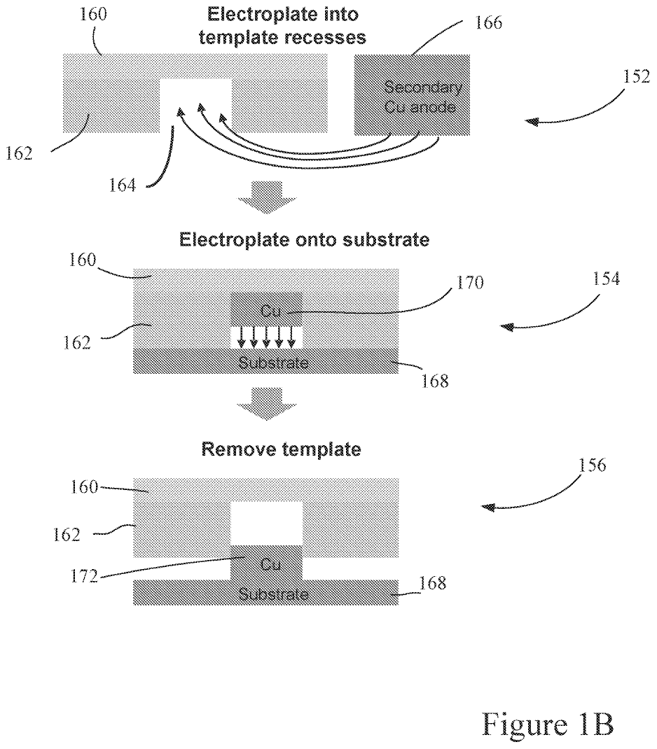

For context, a two-phase printing process may be part of an integrated electronic device fabrication process. Examples of such fabrication processes are depicted in FIG. 1A. The operations in a process shown in FIG. 1A may be performed in different orders and/or with different, fewer, or additional operations.

As illustrated, a two-phase printing process 100 may begin at a at a block 102, where a print head is loaded. In some implementations, a semiconductor substrate may be loaded as well. By way of an example, the print head and/or the semiconductor substrate may be loaded in a print head or substrate load/unload station. The loading operation may place the print head and multiple substrates in an electroplating apparatus with one or more plating stations. For example, multiple substrates may be provided to a FOUP.

At block 104, the print head and, in some embodiments, a semiconductor substrate optionally undergo a pre-treatment. Pre-treatment of the print head may remove impurities. Pre-treatment of the semiconductor substrate may reduce oxides and/or remove impurities such as organic impurities. In addition, the pre-treatment may involve vacuum surface pre-wetting. By way of an example, the print head and/or the semiconductor substrate may be transferred from a load/unload station to a print head and/or substrate pre-treatment station via a robot. In some cases, the pre-treatment station is configured as a vacuum backfill station. In some cases, the pre-treatment station is configured as an acid pre-wetting station.

In some implementations, the print head is loaded at a particular time and then remains associated with a particular electroplating station for an extended period, during which multiple substrates are processed in that station via operations 102 and 104.

In preparation for electroplating, at a block 106, the print head, and optionally a semiconductor substrate, are immersed in electrolyte in an electroplating station. The plating station may also be referred to as an electroplating vessel, electroplating cell, plating chamber, etc. The plating chamber is configured to contain an electrolyte and one or more secondary anodes while electroplating metal into recesses of the print head. By way of an example, the print head may be transferred from the pre-treatment station to an electroplating station via the robot. Electroplating operations may be performed in one or more electroplating stations.

The print head template layer is immersed in the electrolyte containing ions of the metal to be electroplated, and the print head is cathodically biased via electrical contacts made to its conductive layer. In some examples, the electrolyte contains copper ions, acid, plating additives, and the like as discussed elsewhere herein. In the presence of a template layer, the intermediate resistive layer, and the conductive layer (all present in the print head), the ionic current distribution is relatively uniform over the template layer.

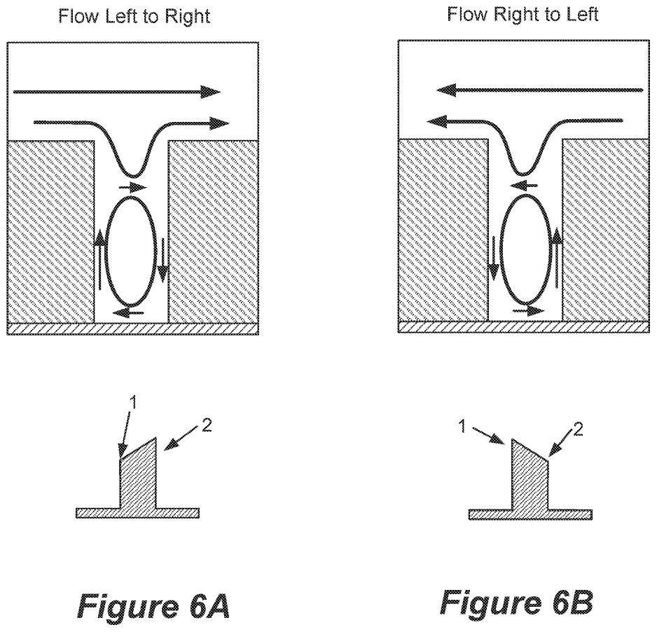

In some embodiments, electrolyte convection is provided to achieve a particular spatial and/or temporal deposition pattern in print head. See block 108. Convection increases the rate at which electroplating can occur in a feature and can promote uniform plating. Furthermore, a bias in flow conditions may create a misshapen deposited feature in the print head, which could potentially cause the subsequently deposited feature to grow irregularly on the substrate. For instance, in FIGS. 6A and 6B, if flow fields occur in one direction, then non-uniform feature profiles in recessed features are produced. Therefore, during the step where the print head is being filled with metal, convection (e.g., “cross” or “shearing” flow) is useful not only to allow for increase rate of the process but to provide uniform feature shape deposition. In this regard, the convection may be uniform in direction and intensity, when averaged over the time of the feature-filling step. Some options for enabling convection meeting these criteria include rotation of the print head and providing a reciprocating paddle in the electroplating station.

In some implementations, electrolyte flows laterally across a print head's template layer. In such embodiments, the electrolyte flows substantially in one direction entering and exiting the plating chamber at azimuthally opposite positions proximate the perimeter of the chamber. As the electrolyte flows laterally, the print head is optionally rotated. However, it will be understood that alternative techniques may be employed for achieving improved uniformity within features, such as enabling the flow beneath the print head to come from a set of or continuously different directions.

With the template layer of the print head immersed in electrolyte and the electrolyte optionally flowing with respect to the template layer, a cathodic current or voltage is applied to the conductive layer of the print head in order to cause electroplating of metal from a secondary anode into the template features of the print head. See block 110. As explained, the electroplated metal deposits on an intermediate insulating layer of the print head, not on the conductive layer of the print head. This process is schematically illustrated in an upper panel 152 of FIG. 1B. Note that during this electroplating operation, there is a gap between the print head and the secondary anode. If a semiconductor substrate is present in the plating station, it may be disposed beneath the print head, and hence a gap exists between the substrate and the print head.

After metal is fully electroplated into the recesses of the template layer, the print head is moved into proximity with or contact with the substrate on which printing will occur. See block 112. This prepares the print head and the substrate for the printing operation.

During printing, metal is electroplated from the recesses of the print head onto the substrate. See block 114. This printing operation is schematically depicted in the middle panel 154 of FIG. 1B. In the depicted embodiment, the template layer surface contacts the substrate, but the metal plated in the print head does not contact the substrate. Rather electrolyte separates the metal from the substrate. The electrolyte sits in the small gaps between the plated metal and the substrate.

During the printing, the print head serves as an anode and the substrate serves as a cathode. After the printing operation is complete, the template and substrate separate from one another. This is depicted in the lower panel 156 of FIG. 1B.

In some embodiments, the semiconductor substrate may have a conductive seed layer such as a copper seed layer. The conductive seed layer may be disposed on a material layer such as a dielectric layer. The semiconductor substrate may be a partially or fully fabricated semiconductor substrate comprising one or more dice having a distribution of features.

At a block 116, the semiconductor substrate may undergo substrate post-treatment. In some embodiments, the substrate post-treatment can include rinsing, drying, and/or cleaning operations in a rinse/dry/clean station. In some embodiments, the substrate post-treatment can include etching in an etching module. Etches may be performed to selectively remove patterned features or non-patterned features. Removal of patterned features may only remove portions of the patterned features to achieve coplanarity. Thus, the process may include both electroplating and etching operations.

As shown in FIG. 1B, a print head may include resistive layer 162 and a template layer 160. It typically also includes a conductive layer, which is not shown in FIG. 1B. The template layer 160 includes multiple recessed features, one of which is depicted by numeral 164 in the figure. In the first operation (depicted in panel 152), cathodic current flows into recess 164 and anodic current flows into a secondary electrode 166. As a result, metal (copper in this example) plates in recessed feature 164. The plated copper is illustrated by numeral 170 in the second panel 154 of FIG. 1B.

During the second phase, the print head is brought into proximity or contact with a substrate 168, and anodic potential is applied to the print head while a cathode potential is applied to the substrate 168. This results in metal 170 from the recessed feature 164 to electroplate (print) onto the substrate 168, but only in the region of recessed feature 164. See panel 154.

After the metal 170 from the recessed feature 164 is fully electroplated onto substrate 168, the print head is separated from the substrate to expose newly printed metal feature 172. See panel 156.

It is typically desirable for the rate of deposition within recessed features to be uniform, i.e., at the end of the process each feature has a similar height of metal deposited and is thus coplanar. This may be accomplished by carefully controlling the deposition conditions including electrolyte composition and convection. Concentration of plating additives may be controlled to improve co-planarity and reduce metal feature height differences within a die or within a wafer.

Within-wafer (WIW) uniformity is an industrially important metric measuring variations of features over a wafer. WIW uniformity compares the average thickness distribution of multiple dies over a substrate and may provide an indication of how the process will be for different die from different location for a set of die coming from the wafer. The WIW distribution can be non-uniform due to various factors, including but not limited to variable flow, non-uniform edge electric fields, discontinuities in the feature layout (e.g., missing die regions), and wafer edge contact uncompensated seed resistance terminal effects. The methods and apparatuses of the present disclosure is not subject to the underlying inherent physicochemical causes for these effects, and therefore can improve the WIW uniformity (in operation 1 or operation 2) relative to conventionally employed electroplating apparatuses and methods.

Within-die (WID) uniformity is a measure of the variable thickness of all the features within the die and can be compared relative to the wafer total feature thickness distribution and relative to other die. For example, small WID variability makes developing overlaying film of subsequent layers less challenging and more reliable, or bonding to pillars and pads of multiple features across die between two different die less challenging and more reliable. Even when the electric and flow fields are uniform over a die, WID non-uniform plating may occur. A thickness distribution of the various features within the die are primarily driven by a variability in exposure of various features and regions of features. This is sometimes referred to as a “feature density distribution” or the “loading effect,” and occurs because the electric and mass transfer field resistances around features and regions of features of lower densities are less than for regions of denser features. The apparatuses and methods of the present disclosure can improve the WID uniformity (in operation 1 or operation 2) relative to conventionally employed apparatuses and methods, in part because the variability in electric and mass transfer field resistance due to loading that conventionally exists, are not operative when using a plating apparatus in which each feature is plated electrolytically separated for each another.

Within-feature (WIF) uniformity is a measure of the shape of the top surface of a feature's flatness relative to a base plane and relative to other features. For example, small WIF uniformity makes developing overlaying film of subsequent layers less challenging or more reliable or bonding individual pillars and pads of two different die less challenging and more reliable. The apparatuses and methods of the present disclosure can improve the WIF uniformity (in operation 1 or operation 2) relative to conventionally employed apparatuses and methods.

As explained, the first operation may be performed in a manner that electroplates metal in the print head template recesses uniformly, regardless of feature loading differences and/or the terminal effect. This occurs because the print head design transfers the controlling resistance to what may be called a swamping resistor, which may be implemented as a thin resistive layer described herein. Depending on implementation details, a swamping resistor enables substantially uniform electrodeposition of metal both at the feature-to-feature level and across the entire print head level.

When filling the electrode features with metal on any patterned surface, the electrical resistance primarily varies from feature to feature based on the features' relative exposures to the electrolyte solution. Isolated features have a relatively parallel path from the electrolyte to their surfaces compared to features with many close neighbors. As a result, the isolated features tend to plate much faster. If uncompensated, this phenomenon would produce a variable thickness of metal across different features. The thin layer of resistive material introduces a resistance to the electroplating process that is larger than the inherent electrolyte resistance to a patterned print head, and thereby swamps out the otherwise feature to feature resistance variability, leading to a near constant plating current density and deposition rate for all plated features on the print head.

Once the patterned print head is uniformly filled with metal, that metal is transferred to the substrate (second operation) in substantially the same shape as the target pattern created on the print head, allowing for a very uniform thickness printed pattern to be obtained.

In certain implementations, two phase processes of this disclosure print multilayer structures on a substrate. The individual layers of such structures may have different compositions. For example, the printed structures may have one layer of first metal and a second layer of a second metal. Example combinations of metal layers may include any two or more of the following: a copper layer, a nickel layer, and a tin layer. In some embodiments, three or more layers make up a multilayer printed structure. In some embodiments, multiple alternating layers of two or more metals make up a multilayer printed structure.

There are several possible process sequences. Some of these involve depositing multiple layers of metal into the recesses of a print head prior to printing the metal layers onto a substrate. Other sequences deposit and print each layer separately.

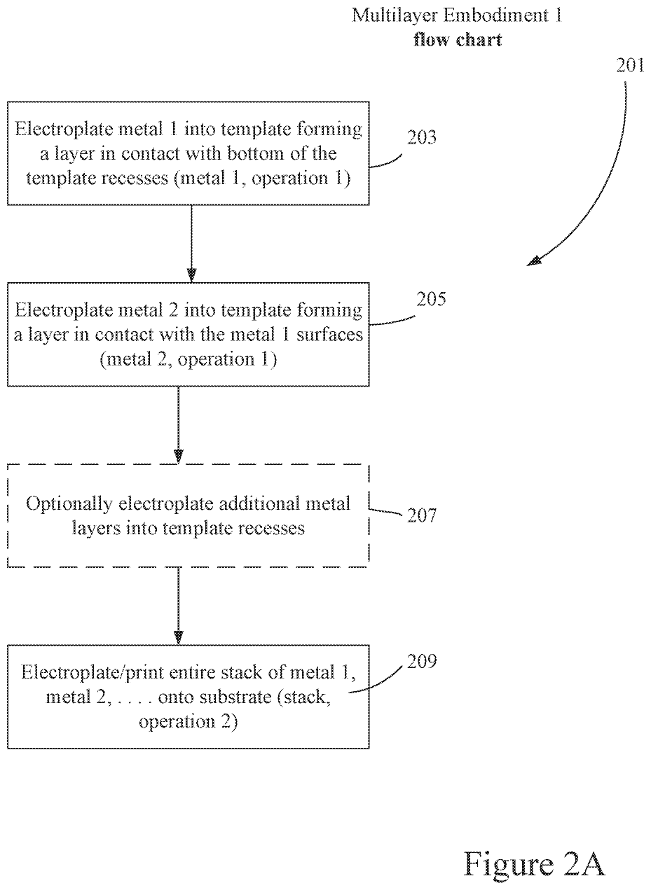

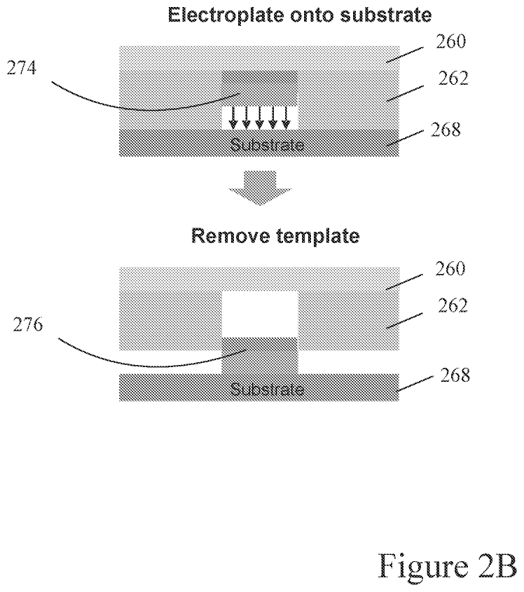

In certain embodiments, exemplified in FIGS. 2A and 2B, a process sequence 201 includes: (a) electroplating a first metal (metal 1) into a template layer of a print head and thereby forming a layer of metal 1 in contact with the inert anode surfaces (metal 1, operation 1, block 203); (b) electroplating a second metal (metal 2) from a different electrolyte composition containing a second metal into the template layer, thereby forming a layer in contact with the metal 1 surfaces (metal 2, operation 1, block 205); optionally (c) electroplating one or more additional metal layers into template layer recesses (operation 205); and (d) electroplating (printing) the entire stack of metal 1, metal 2, . . . onto a substrate (stack, operation 207).

FIG. 2A illustrates operation 2 of a stack printing process schematically. A print head having a resistive layer 260 and a template layer 262 with a recess therein, has had a metal stack 274 (two or more metal layers) in its recess. The print head with stack 274 therein contacts a substrate 268. See upper panel. After contact, an anodic potential is applied to the print head and a cathodic potential is applied to the substrate 268. This causes stack 274 to transfer to substrate 268 where it forms printed feature 276, which comprises multiple layers. See the lower panel.

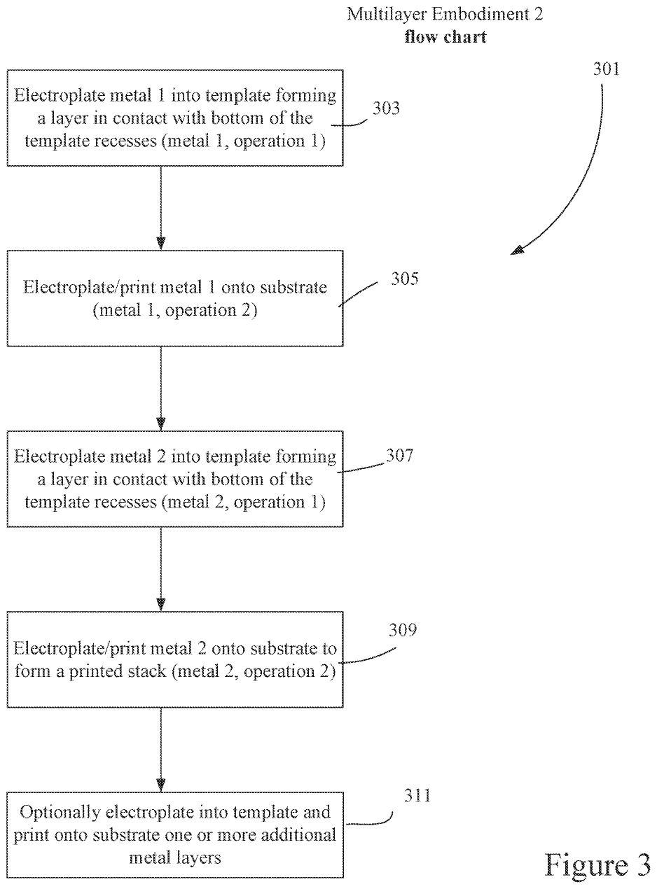

In certain embodiments, exemplified in FIG. 3, a process sequence 301 includes: (a) electroplating a first metal (metal 1) into a template feature and forming a layer in contact with a surface of a resistive layer (metal 1, operation 1, block 303); (b) electroplating (printing) metal 1 onto a substrate (metal 1, operation 2, block 305); (c) electroplating metal 2 into the template feature and forming a layer in contact with the resistive layer surface (metal 2, operation 1, block 307); (d) electroplating (printing) metal 2 onto the substrate to form a printed stack (metal 1 and metal 2, operation 2, block 309); and (e) optionally electroplating into template feature and printing onto the substrate one or more additional metal layers (operations 1 and 2, block 311).

The electrolyte used to transfer the multi-metal stack from the print head to the substrate may be free of all electroplatable metals, may include the metals contained in the stack, or may contain only the metal of the first metal to be transfer to the substrate (the one that is bonding to the product substrate metal seed layer). Examples include a solution of acid only (e.g., 180 g/L sulfuric acid), or a solution of 80 g/L copper sulfate and 5 g/L sulfuric acid (when depositing a first layer of copper).

### Print Head Design

A print head may have a template layer and two or more additional layers. As indicated, a template layer may include recessed features defining a pattern to be printed on a substrate. The additional layers may provide a conductive surface for delivering an electrical potential over the region occupied by the template features. The layers may be configured to provide that electrical potential substantially uniformly over the region of the template features, regardless of local feature density and regardless of distance from a bus or contacts to the electrical power. In certain embodiments, the additional layers include a highly conductive metal layer covered with a thin resistive film. During the first operation (described above), a printable pattern is formed on the resistive film, within the template layer's recesses. During the second operation, metal from the printable pattern is electroplated onto a substrate surface.

In certain embodiments, a print head may be characterized by the following elements: (a) a template layer comprising a non-conductive material having recesses or openings defining a pattern of conductive material to be printed on a substrate, (b) a conductive layer overlying the pattern of conductive material; and (c) a resistive intermediate layer disposed between the template layer and the conductive layer.

FIG. 4A is a cross sectional illustration of a print head 401 that includes substrate 403, an electrically conductive layer 405, a resistive layer 407, and a template layer (also referred to as a mask) 409. The template layer 409 includes multiple recessed features 411 that extend from an exposed face or surface of template layer 409 to the resistive layer 407. The recessed features 411 define at least a portion of a pattern that is to be printed onto a work piece (e.g., a semiconductor wafer).

The substrate 403 supports the conductive layer 405, the resistive layer 407, and the template layer 409. It may be made of any mechanically stable material that does not negatively interfere with the delivery of an electrical field to template layer. As examples, it may be made from a glass, a plastic, a ceramic, or semiconductor material (e.g., silicon), or any combination of these. It should be distinguished from the “substrate” on which metal is electroplated in a second operation of the printing process.

### Template Layer

A template layer has recessed features that collectively map to the layout or pattern of the structure that is to be printed onto a substrate such as a semiconductor wafer. In certain embodiments, the pattern of conductive material to be printed on the substrate comprises a wafer level packaging (WLP) pattern. As an example, the WLP pattern is an RDL pattern and/or a pillar pattern.

In various implementations, a different template layer is required for each application. That is, a template layer for a given application has a fixed pattern. A single template layer having a fixed pattern (typically on a single print head) is employed to print a pattern on many substrates. A different template layer having a different fixed pattern is employed to print the different pattern on many substrates.

In certain embodiments, template layer comprises a non-conductive material such as a glass, a polymer (e.g., a photoresist or other polymer such as an epoxy), an oxide (e.g., a silicon oxide), and the like. In certain embodiments, the recesses or openings in the template layer have a thickness of about 5 to 300 micrometers.

### Conductive Layer

As explained, a conductive layer is employed to provide an electrical field in the recesses of the template layer during electroplating. In certain embodiments, the conductive layer has a sheet resistance of at most about 0.1 ohm/square. In certain embodiments, the conductive layer has a thickness of about 0.01 to 10 micrometers. In some implementations, the conductive layer comprises a conductive metal such as copper, nickel, cobalt, titanium, or any combination thereof. In one example, a conductive layer is a 6000 A thick layer of copper deposited by, e.g., PVD.

### Resistive Layer

As explained, a resistive layer may be interposed between a template layer and a conductive layer. It serves to swamp local electrolyte resistance variations caused by, e.g., feature loading and/or to swamp edge-to-center ohmic potential drops in the conductive layer. The resistive layer therefore helps generate a substantially uniform electric field over the entire printing region of the print head.

In certain embodiments, the resistive layer has a conductivity of about 10⁻⁵ to 10⁻⁷ S/cm.

In certain embodiments, the resistive layer has a porosity of less than about 5%. In certain embodiments, such a resistive layer has a thickness of no greater than about 0.2 times, or about 0.1 times, the smallest pitch or the critical dimension of the pattern of conductive material to be printed on a substrate. In certain embodiments, a resistive layer has a thickness of about 0.05 to 10 micrometers. In some implementations, a resistive layer comprises a carbon film such as a hydrogenated amorphous carbon film, optionally deposited by sputtering, or by decomposing an organic compound such as a polymer, and/or by converting to a carbon film by a thermal treatment (e.g., about 400-600 C) in an inert atmosphere. A resistive layer may be made from other materials such as polymers, semiconductors, ceramics, glasses, and the like.

In some embodiments, the resistive layer provides a continuous layer that is substantially coextensive with the pattern of the template layer. In some embodiments, the resistive layer comprises two or more discrete portions that, at a minimum, cover all or substantially all openings through the template layer.

In certain embodiments, the template layer and the resistive layer are merged. That is a single component of the print head-optionally a monolithic component-comprises both the template layer and the resistive layer. In some implementations, the merged component contains a single material such as a silicon oxide or a polymer.

### Consumable Anodes

When in use, the second operation electroplates metal from template recesses of the print head onto a substrate. Thus, metal in the print head (electroplated there after the first operation) serves as a consumable anode, not an inert anode. In theory, inert electrodes could serve as anodes during printing, but these can require special treatment to suppress oxygen evolution, which could introduce defects into devices fabricated on the substrate.

### Addressable Electrodes

In certain embodiments, the conductive layer is a continuous sheet of conductive material that may span all or most of the region occupied by the pattern in the template layer. In such embodiments, only a single connection or circuit is needed for the print head. In alternative embodiments, the conductive layer is not continuous but is comprised of two or more discrete or separated sections, which may be independently addressable. Such embodiments may employ a thin film transistor based micro anode array of patterned features (features of various length sizes shapes to match a required wiring pattern). In such approach, each feature may require a separate and unique wiring control circuit.

### Contact to Conductive Layer

In certain embodiments, electrical connections to the print head are made at the periphery of the head and to the conductive layer. In some cases, the electrical connections are made at the periphery of the head in a manner to feed current uniformly around the peripheral area. This can employ multiple parallel feed lines and contact points around some of all the periphery of the conductive layer. Or it can employ a large current carrying bus connected to a main power lead. Such bus can continuously contact the conductive layer.

FIG. 4B is a schematic illustration of one embodiment of a print head 421 having a peripheral bus 435 electrically connected to the peripheral region 428 of a conductive layer 425. FIG. 4B includes a plan view (left panel) and a cross-sectional view (right panel) of print head 421. The print head itself includes an insert substrate 423 on which is formed the conductive layer 425 and a template layer 429. An intermediate resistive layer is not depicted, nor are recesses in the template.

### Method of Fabricating a Print Head

A print head as described herein may be fabricated by various techniques. In some embodiments, a print head is fabricated using the following operations: (a) forming a conductive layer; (b) forming resistive intermediate layer over the conductive layer; and (c) forming a template layer on the resistive intermediate layer, where the template layer has a non-conductive material with recesses or openings defining a pattern of conductive material to be printed on a substrate. In some embodiments, the pattern of conductive material to be printed on the substrate comprises a WLP pattern.

In some cases, the conductive layer has a substantially uniform thickness of conductive material. In some cases, the resistive intermediate layer has a substantially uniform thickness of a resistive material. Generally, the properties of the electrically conductive layer, the resistive layer, and/or the template layer may be as described elsewhere herein.

In some embodiments, forming the template layer includes the following operations: (i) electroplating a metal pattern into recesses of a patterned photoresist or other material that can be selectively removed while leaving behind metal features by, e.g., ashing, dissolving in a solvent, and the like; (ii) removing the photoresist or other material from the around the metal pattern; (iii) coating the metal pattern with a dielectric material to thereby fill recesses around the metal features of the pattern; and (iv) removing raised metal features of the metal pattern to form the template layer. The remaining dielectric of the template layer may possess a “negative” image of the metal pattern, while the metal pattern may possess a “positive” image of the pattern to be formed on a substrate during the second operation of the two-phase process described herein.

In some examples, forming the template layer includes the following operations: (i) depositing a conductive seed layer on a partially fabricated print head that includes resistive intermediate layer over a conductive layer; (ii) applying and patterning a photoresist on the seed layer; (iii) electroplating metal into recesses of the photoresist; (iv) removing the photoresist from the seed layer: (v) etching away the conductive seed layer in regions where the metal was not electroplated (this produces raised metal features); (vi) coating the raised metal features with a layer of dielectric; (vii) planarizing the layer of dielectric to expose the raised metal features; and (viii) removing raised metal features to form the template layer.

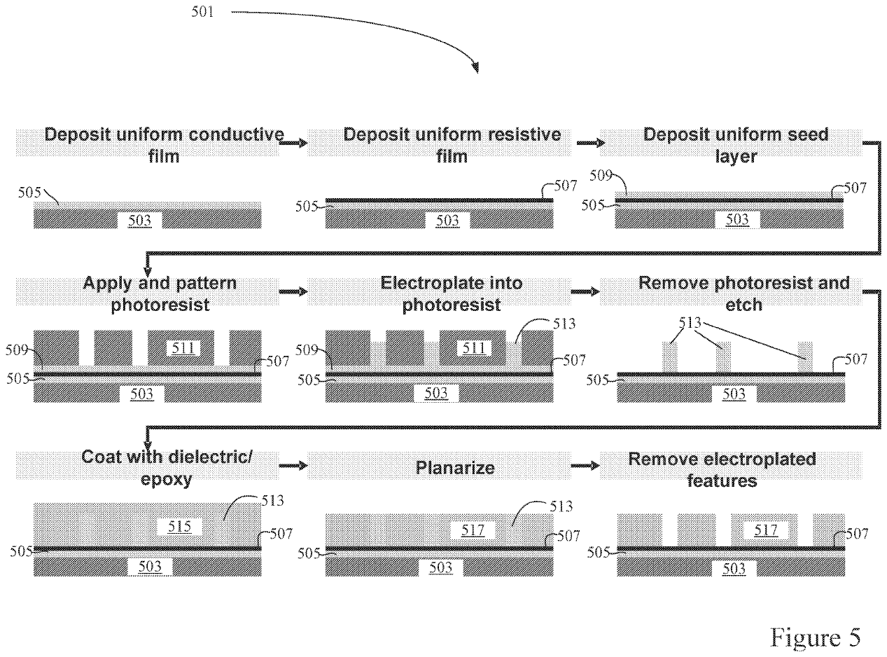

FIG. 5 illustrates a sequence of operations 501, some or all of which may be used to fabricate a print head. Initially, as depicted in an upper left panel of FIG. 5, the fabrication process may begin with a partially fabricated print head having a substrate 503 and a conductive layer 505. These elements remain in place for the remainder of the depicted process. Next, as depicted in the upper central panel, an intermediate resistive layer 507 is formed over/on the conductive layer 505. The resistive layer 507 remains in place during the remainder of the fabrication process. Next, a depicted in the upper right panel, the process deposits an electrically conductive seed layer 509 on the intermediate resistive layer 507. Seed layer 509 may be formed from metal that is to be subsequently electroplated. One example is copper. Seed layer 509 may be substantially uniformly deposited by a process such as physical vapor deposition.

Next, as depicted in the middle level left panel, the fabrication process forms a patterned sacrificial layer 511 defining a template for a pattern to be electroplated (which may represent a final pattern such as a WLP pattern to be provided on a semiconductor device or wafer). In some embodiments, the sacrificial layer 511 is a photoresist layer, that is applied and then patterned using, e.g., a lithographic process. As illustrated, layer 511 has recesses, which define a pattern for a subsequent electroplating process, which is depicted in middle center panel. As shown there, a metal 513 is electroplated into the recesses of patterned layer 511. The electroplating employs the exposed surfaces of the seed layer 509. After electroplating, and as illustrated in the middle right panel, the photoresist or other sacrificial material of layer 511 is removed. Additionally, the remaining seed layer material (from layer 509) that was under the material of layer 511 is etched away or otherwise removed to leave electrically isolated protruding electroplated features 513. Next, as illustrated in the lower left panel, the partially fabricated print head having protruding metal features 513 is coated with a layer of dielectric 515 such as a polymer (e.g., an epoxy). This dielectric serves as the material that makes the template layer of a finally fabricated print head. Because the dielectric fully encases the metal features 513, which ultimately must be selectively removed, the partially fabricated print head may be planarized, as depicted in the lower center panel, to expose the top surfaces of features 513. The resulting dielectric material may define a template 517. Thereafter, the fabrication process is completed by removing the electroplated metal features 513 by, e.g., a selective metal etch process (wet or dry). This leaves the final template layer 517 on the intermediate resistive layer 507 and over the conductive layer 505. See the lower left panel.

Platform for Direct Electroplating onto a Substrate

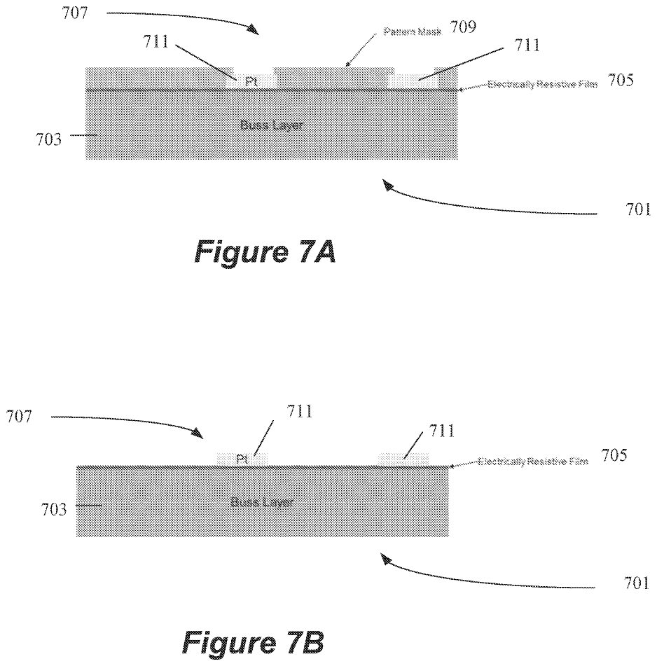

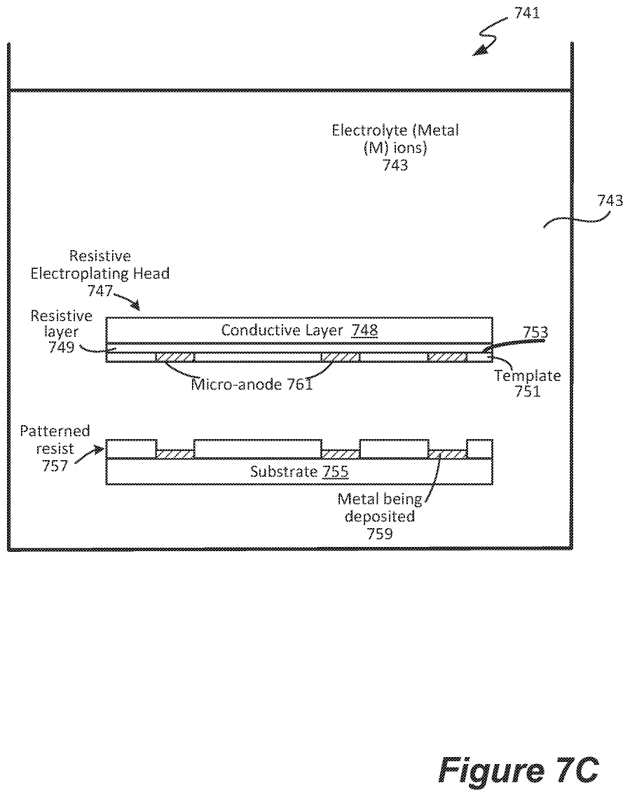

A platform and associated electroplating chamber(s) for performing two phase printing using a print head may have many different configurations. Examples of such platforms and chambers are illustrated in FIGS. 7-9. Note that some embodiments employ the same electroplating chamber for both phases of a printing process. However, the following discussion describes key features and examples of apparatus for each phase separately.

In certain embodiments, the first operation employs an electroplating system having (a) a print head as described herein (e.g., having recessed features defining a pattern to be printed on a substrate); (b) a chamber comprising a support configured to hold a secondary anode; and (c) a controller configured to cause electroplating of a metal into the recessed features of the print head. The secondary anode may be composed of the metal to be electroplated onto the print head, or may have an appropriate metal surface to function as an inert anode (e.g., a platinum film).

The secondary anode located at many different locations in the chamber, so long as it contacts the electrolyte when metal is being electroplated into the print head. When the resistance of the template is sufficiently high, the current distribution will be sufficiently uniform over the various features and locations of the template that the location of the secondary anode vis-à-vis the print head is not critical to providing uniform electroplating. As examples, the secondary anode may be located off to side of print head, as a concentric ring or surrounding polygon around the perimeter of the print head, as a slab underneath the print head (substantially coplanar with the template). The secondary electrode may be of an inert or active metal type as known in the art and may include supporting hardware to enable a separated anode compartment for avoiding various deleterious reactions of the exposure to the catholyte (see Mayer et al., U.S. Pat. No. 6,527,920 issued Mar. 4, 2003). In one embodiment, the secondary electrode used for filling the print head with metal is substantially the same shape and/or size as the substrate on which metal is subsequently printed. For example, if the substrate is a 300 mm wafer, the secondary electrode may be a disk shaped wafer of about 300 mm diameter.

In some embodiments, an electroplating chamber used to plate metal onto a print head is configured to provide electrolyte convection during this step. Such convection may increase the rate at which electroplating can occur in the template recesses in a uniform fashion.

Further, convection may be implemented in a way that improves within-feature shape flatness or uniformity. Any directional and/or time bias in flow may create a misshapen feature that would potentially cause the subsequently deposited feature to grow irregularly. In certain embodiments, an electroplating chamber is configured to perform convection in a way that increases the electroplating rate and does so while providing uniform deposition in direction and intensity when averaged over the time of the recess-filling. Some examples for enabling convection meeting these criteria including (1) rotating the print head during electroplating, (2) pushing the electrolyte back and forth over the print head surface (e.g., via a reciprocating paddle in the electroplating chamber), (3) flowing electrolyte substantially perpendicular to the surface of the template of the print head via showerhead or related structure that optionally provides jets of electrolyte that impinge on the print head surface, and (4) flowing electrolyte substantially parallel to the print head surface and at high rate where the flow is confined in the channel between a high ionic resistance plate and the print head. Examples 2, 3, and 4 may optionally be implemented in a manner that rotates the print head during electroplating.

In certain embodiments, an electroplating chamber includes an electrolyte injection flow system designed to produce flow parallel to the semiconductor substrate. The flow of electrolyte across the surface of the semiconductor substrate may occur at high velocities. Further, the electrolyte injection flow system is designed so that the flow of electrolyte is parallel to the print head. The print head may be positioned in the plating chamber so that there is a thin gap between the print head and the semiconductor substrate.

The plating chamber may include a cross-flow manifold to promote cross-flowing of electrolyte across the substrate surface. The cross-flow manifold may be configured to contain an electrolyte flowing over the surface of the print head. The cross-flow manifold may also be referred to as a flow injection manifold. The flow injection manifold may be a cavity with a series of exit holes around its periphery and under a cross-flow confinement ring. The flow injection manifold may serve to create an azimuthally uniform injection of flow into a cross-flow gap. In an alternative embodiment, spatially distributed electrolyte through holes may be placed in the print head to allow for the injection of fresh electrolyte to enter a gap from spaces and holes between print head and opposite a gap that may be bounded by the secondary anode and exit the gap from the general periphery.

FIGS. 6A and 6B illustrate schematic diagrams of flow direction of electrolyte and its impact on plating within a template recess. If the flow were uniform over time, convection inside recessed features defined by the template layer would be uni-directionally biased. In FIGS. 6A and 6B, a cross-sectional schematic of a recessed feature within a template layer is shown, where a bottom of the recessed feature includes exposed portions of a resistive layer adjacent to a conductive layer. The arrows represent a flow field and direction of flow for the electrolyte. When electrolyte flow proceeds from left to right, the flow field generates a clockwise rotation of flow (eddy) inside the recessed feature as shown in FIG. 6A. When electrolyte flow proceeds from right to left, the flow field generates a counterclockwise rotation of flow inside the recessed feature as shown in FIG. 6B. Given that deposition of metal can proceed under mass transfer limitations of the depositing metal ion in the electrolyte, a downstream position at a base of the eddy receives a more replenished, higher concentration of metal ion flow than an upstream position at the base of the eddy. This is because electrolyte metal ions are consumed more at the downstream position first and becomes depleted therefore before traveling towards the direction of the upstream position. As shown in FIG. 6A, deposition occurs at a faster rate at position 2 (downstream position) than at position 1, and the thickness at position 2 is greater, leading to a non-uniform feature profile. As shown in FIG. 6B, deposition occurs at a faster rate at position 1 (downstream position) than at position 2, and the thickness at position 1 is greater, leading to a non-uniform feature profile that is the opposite in direction to FIG. 6A. If, over the course of electroplating operations, the direction of flow is both left-to-right and right-to-left for equal durations, then the aforementioned mass transfer bias and undesirable non-uniform feature profile may be avoided. This applies not only in 2-dimensions but also in 3-dimensions. Thus, applying a bi-directional flow only in 2-dimensions (e.g., left-to-right and right-to-left) leaves a bias in a third dimension. Enabling a flow direction into and out of the page, some but not necessarily all the bias is removed in the third dimension. By continuously changing the direction of flow over time to include equal flow velocity in all directions, a uniform mass transfer exposure can be achieved. One way to enable angular uniform mass transfer exposure is to rotate the print head at a fixed rotation rate around the linear flow field in a plating gap during an electroplating process. Alternatively, the rotation rate and/or direction can change during the electroplating process. In some embodiments, the rotation speed can change rapidly such as over a time that is small relative to the duration of the electroplating process, or the rotation speed can change continuously over the entire duration of the electroplating process (e.g., slowly ramped rotation rate).

As indicated, in certain embodiments, both the first and second operations are performed in the same chamber. In other embodiments, they are performed in separate chambers. Generally, an electroplating system for the second operation employs the following elements: (a) a print head comprising recessed features defining a pattern to be printed a substrate; (b) a chamber comprising a support configured to hold the substrate while electroplating occurs on it, and (c) a controller configured to cause electroplating the metal from the recessed features of the print head onto the substrate.

In certain embodiments in which the same chamber or station is used for the both the first and second operations, during the first operation, the print head is loaded and held in an electroplating station in the same manner and location as a substrate in a conventional electrofill cell. Also, during the first operation, the secondary electrode element is loaded into the plating station and used as an anode for electroplating into the print head. After the first operation is complete (i.e., metal is electroplated into recesses of the print head), the secondary electrode is removed from the station, allowing the substrate (e.g., semiconductor substrate) to be loaded into the station in its place and the metal previously plated onto the print head is be transferred/printed onto the substrate (i.e., the substrate is held at a cathodic potential and the print head is held at an anodic potential). In some embodiments employing the same station for both operations, the secondary electrode is substantially the same shape as the substrate (for example, if the substrate is a 300 mm wafer, the secondary anode may be a disk-shaped structure of approximately 300 mm diameter).

In certain embodiments, a platform optionally includes an automated robotic feature configured to move a print head and substrate between various process stations which may including one or more of the following: 1) a front end FOUP station, for holding/storing one or more print heads or one or more defining pattern, 2) a print head plating station including a counter electrode that is not the substrate, 3) a substrate plating station having a print head that functions as the counter electrode (anode), and any station mentioned below. In certain embodiments, a substrate plating station includes a robotic and automated feature configured to insert and remove a print head to/from a substrate plating station and make appropriate electrical contact to the print head. Some embodiments include positional and sealing features configured to operate the print head as an anode in close proximity to the substrate. In certain embodiments, a platform includes one or more wafer/substrate and pretreatment stations configured to treat either or both of the substrate and print head by, e.g., chemical exposure and spray, immersion, or vacuum wetting. In some embodiment, a platform includes one or more post plating process chambers configured to perform post process treatments such as chemical treatments and spin rinse drying of either or both a substrate or print head.

In certain embodiments, the electroplating system has an actuator or other control device configured to control a gap between print head surface and the substrate. Different gaps may be used for operations 1 and 2. A controller in conjunction with the actuator may be configured to (i) provide a first gap between the print head and the substrate while electroplating the metal from a secondary anode into the recessed features of the print head (operation 1), and (ii) provide a second gap between the print head and the substrate while electroplating the metal from the recessed features of the print head onto the substrate (operation 2). In many embodiments, the second gap is smaller than the first gap. As examples, the first gap may be about 200 micrometers or greater and the second gap may be about 1 micrometer or less. In certain embodiments, the print head contacts the substrate while electroplating the metal from the recessed features of the print head onto the substrate (operation 2). See, e.g., FIG. 1B (154).

In embodiments in which the electroplating system prints a stack comprising two or more printed layers (e.g., a stack comprising layers including two or more of Cu, Ni, Sn), the electroplating system may employ a separate chamber for each of multiple versions of operation 1. In the case of a three-layer stack, for example, metal 1 is electroplated in an upper location in print head features (deepest within template recesses), metal 2 is electroplated at an intermediate location (contacting metal 1) in the print head features, and metal 3 is electroplated at lower location (contacting metal 2 but exposed to electrolyte). Each of these three electroplating operations can be performed in its own dedicated electroplating chamber, with electrolytes and/or anodes optimized for plating the respective metals. In an alternative embodiment, a single chamber is employed for operation 1 and the electroplating chemistry is changed for electroplating each of the metal layers separately.

In some embodiments, after the stack of metals is electroplated into recesses of the print head, operation 2 is performed in a single chamber, in which the entire stack is printed onto a substrate.

### Patterned Electrically Resistive Anode

In certain embodiments, a patterned electrically resistive anode, similar to the print head described herein, is used to electroplate features onto a substrate through a patterned mask on that substrate. Such mask may be, for example, a patterned photoresist on a substrate, such as is patterned silicon wafer, commonly used in through-resist electroplating to create connecting bumps between substrates, or current carrying lines on or within one. In this embodiment, the plated features are defined by the photoresist pattern on the substrate, which ensures that the metal is plated exclusively into the regions defined by the mask features. The patterned electrically resistive anode serves as one example of a type of anode that directs current in a particular pattern to minimize variances in the thickness of plated metal between and among the various patterned feature.

In some such embodiments, a patterned electrically resistive anode employs two or more small size scale (e.g., about 5 to 200 μm diameter or largest dimension) inert anodes, as opposed to the commonly used single inert or active anodes as known in the art. Generally, the small anodes may comprise a dimensionally stable inert metal or alloy, or an active metal such as copper, or other material to be electroplated onto the substrate. The separated anodes of a patterned electrically resistive anode may be exposed surfaces separated by an insulated masking material, referred to elsewhere herein as a template layer (e.g., photoresist, epoxy, silicon dioxide) that are distributed in a targeted fashion across the anode surface so as to spatially match and correlate with, and ultimately improve the feature plating uniformity of a particular masked through resist substrate. The surface of the anodes exposed to the electrolyte may be catalytic to an electro-oxidation reaction such as hydrolysis or ferrous ion oxidation, and not substantially corrode during the electroplating process. Each of the anodes are substantially coplanar over the patterned electrically resistive anode's surface. The thickness of a template layer (sometimes referred to as a masking layer here) of the patterned electrically resistive anode may be small, e.g., less than about 5 μm. The surface of the anodes that is exposed to the electroplating electrolyte may be composed of a material resistive to electrolytic oxidation and promote a redox oxidation other than the corrosion of the exposed material. Examples of suitable materials for the surface film of each anode are dimensionally stable inert electrode materials (e.g., Ti, Ta, W, and Nb) and noble metals (e.g., Pt, Au, and Ir), or alloys containing any of these.

In some through resist electroplating embodiments, the system is not configured to preload a patterned electrically resistive anode with copper or other metal to be deposited. This is because the electrolyte provides the source of metal to be deposited. Therefore, rather than using a two-phase electroplating operation, these embodiments employ only one electroplating operation (electroplating features into resist features and onto a workpiece surface) and dispense with the depositing of copper into the features of a template on a printing head. Such embodiments may be performed without making contact with the workpiece surface and transferring metal to the workpiece while in contact with the surface.

FIGS. 7A and 7B illustrate examples of a patterned electrically resistive anode 701 that includes a conductive layer 703 that may serve as a bus layer for distributing current evenly over the face of the patterned electrically resistive anode. Adjacent to conductive layer 703 is a resistive layer 705 that may have a structure and function similar to those of the intermediate resistive layer described above for print head embodiments. Finally, patterned electrically resistive anode 701 includes a template layer 707 in contact with resistive layer 705, and opposite conductive layer 703. In the embodiment of FIG. 7A, template layer 707 comprises a patterned dielectric structure 709 with small anodes 711 embedded therein. In the embodiment of FIG. 7B, the template layer does not include a patterned dielectric substrate.

For the application as an anode source (and not a two-step plating and transfer process of contact printing) the resistive portion of a template layer is not always necessary but may be employed to prevent the corrosion of the electrically resistive film. The resistive portion does not serve the purpose of defining where electroplated metal is stored prior to being transfer to a substrate, as needed in the two-step printing embodiment. So, if the electrically resistive film is not oxidized or eroded in the deposition process, then the embodiment of FIG. 7B is sufficient.

A patterned electrically resistive anode used for through resist electroplating may be fabricated by a method analogous to that shown and described with respect to FIG. 5. Further, a patterned electrically resistive anode used for through resist electroplating may have a structure similar to that shown and described with respect to FIG. 4A. However, there are differences in some implementations. Notably, a dimensionally stable inert material such as a catalytic material (e.g., platinum), rather than a resistive material as in the embodiment of FIG. 4A, is typically provided in the regions exposed by the template layer.

By employing the resistive underlying film to create a uniform current density anode surface and then patterning that film to create a plurality of micro anode sources distributed based on a pattern layout to be deposited, an electrochemical deposition system can achieve an improved current distribution for a particular pattern layout. In certain embodiments, the individual anodes do not act independently (i.e., the current to each micro anode cannot be set individually). The inert anode metal surface, e.g., a Pt metal surface, is exposed to the electrolyte. But if the noble metal surface were uniformly distributed over the resistive film, and the substrate surface covered with a patterned mask, the conductive Pt anode layer would defeat the purpose of the resistive film (e.g., current could go through the resistive film, but after passing through it, it could easily be diverted to an electrolyte resistance favored isolated feature, and the current distribution would not be as desired. Therefore, the patterned electrically resistive anode has inert anode metal regions for each micro anode isolated from each other.

### Conductive Layer

The conductive layer of a patterned electrically resistive anode may include any conductive material such as described above in the context of print head embodiments. The conductive layer may serve as a bus to delivering electrical potentially evenly over the area of the patterned electrically resistive anode.

As with print head embodiments described above, the conductive layer of a patterned electrically resistive anode may be a continuous sheet of conductive material that may span all or most of the region occupied by the pattern in a template layer. Such conductive layer may be electrically connected to a bus on, for example, its periphery or its backside. In alternative embodiments, the conductive layer is not continuous but is comprised of two or more discrete or separated sections, which may be independently addressable. Such embodiments may, for example, employ thin film transistors to separately control each electrode section. In such approach, each section of the conductive layer may require a separate and unique wiring control circuit.

### Resistive Layer

As with print head embodiments described above, the resistive layer of a patterned electrically resistive anode may be a continuous sheet of insulating material that may span all or most of the region occupied by the pattern in a template layer. The resistive layer is interposed between a template layer and a conductive layer. It serves to swamp local electrolyte resistance variations caused by, e.g., feature loading and/or to swamp edge-to-center ohmic potential drops in the conductive layer. The resistive layer therefore helps generate a substantially uniform electric field over the entire printing region of the patterned electrically resistive anode. The resistive layer may have a composition and other properties described above with respect to the print head embodiments.

In many embodiments, the resistive layer is thin relative to the separation between individual features, for example about 0.2 or less than, or about 0.1 or less than, the smallest distance between adjacent features edges. This restriction comes from the desire for the individual anodes to exhibit the same anodic current between them, and to not be influenced by variable resistance in the electrolyte. If this film is of the same size as the feature separation, an edge of array feature can draw current from the more internal feature. As a result of these two requirements, the specific resistivity of the film falls within a target range, which is presented elsewhere herein.

### Template Structure

A patterned electrically resistive anode for use in through-resist electroplating may employ a dielectric template portion containing a dielectric material defining a pattern corresponding to features to be electrodeposited on the substrate surface. In portions of the template layer pattern where the dielectric material does not reside, the template structure includes a chemically inert conductive electrode material. Examples of such conductive material include platinum, iridium, gold, titanium, tantalum, tungsten, or niobium. The regions of the template occupied by the conductive material serve as small anodes, sometimes referred to as micro-anodes.

The dielectric portion of the template layer may be relatively thin and often coplanar with micro-anodes. In other words, the patterned electrically resistive anode may have no recesses. As illustrated in FIG. 4A, the micro-anodes may be embedded in a dielectric layer and have surfaces coplanar with the dielectric layer. In some cases, the portions of the template layer occupied by the micro-anodes are relatively shallow recesses. This is because the patterned electrically resistive anode need not serve as a vessel to accommodate copper or other metal that is to be used as an active anode and therefore consumed while electroplating features onto a substrate. Further, if the anode reaction includes hydrolysis and the creation of dissolved oxygen, any bubbles that may be created in the process will not become trapped or blocked in an anode recessed cavity.

In certain embodiments, the template layer has a thickness of no greater than about 5 micrometers, or a thickness of between about 0.1 and 2 micrometers.

While design criteria of the layers of a print head and a patterned electrically resistive anode may be similar, the reason for those criteria may be different. In the printing case, the resistive film's characteristics ensures that the plating into the head between features on the head of different loadings and isolations occurs at the same rate, accomplished by making the resistive films resistance uniform across the surface and between features, and is the dominant resistance in the set of series resistances from the counter electrode to the anode surface. In the case of a patterned electrically resistive anode, the resistance is uniform spatially and is a swamping resistance relative to the variable resistance between features on the substrate (both variable resistance of the local electrolyte environment, i.e., the primary current distribution, and the seed layer resistance center to edge). Stated differently, the layer's total resistance must be greater than that of the electrolyte in the gap between the micro anode and the workpiece, and the resistance of the workpieces seed layer center to edge.

### Electrolyte Chemistry (Inert Anodes)

In certain embodiments, the electrolyte used during the electroplating via a patterned electrically resistive anode has a composition similar to that of the electrolyte used during the first operation of the print head embodiments described herein. For example, the electrolyte may have a composition characterized as follows: cupric ion from, e.g., sulphate (metal ion source) in a concentration of about 10 to 80 g/L or about 20-65 g/L, and sulfuric acid in a concentration of about 5 to 120 g/L of about 20 to 100 g/L. The electrolyte optionally includes one or more additives such as an accelerator, a suppressor, and optionally a leveler that promote bottom-up fill.

When using an inert anode, such as used during electroplating via a patterned electrically resistive anode, one or more modifications to the process may be employed to address generation of acid and/or oxygen bubbles in the electrolyte during the electroplating. This is because oxidative electrochemical half-reactions at the inert anode may result in decreased pH and increased oxygen generation by the breakdown of water (2H₂O→O₂+4H′+4e⁻). Concurrently, metal ions (e.g., copper ions) are depleted at the workpiece by reductive electrochemical half-reactions (2Cu⁺²+4e⁻→2Cu).

The acidification and copper depletion may be mitigated by dosing a solution with known concentrations and volumes of electrolyte, which may, for example, have higher copper concentration and lower acid concentration than the electroplating electrolyte. In addition, the process may periodically remove excess electroplating solution to maintain a consistent overall volume of the system. Such processes may be implemented as “bleed and feed” operations.

In some embodiments, a material is added that reacts with the excess acid generated and releases copper ions in the process. As an example, a solid metal oxide such as copper oxide or cupric hydroxide is dosed. This may be implemented as part of an overall electroplating system bath composition control. A metal oxide dose control unit may be fluidly coupled to the plating solution reservoir. Using the metal oxide in the stochiometric ratio associated with the reaction leads to a balanced overall bath composition. For instance, dosing copper oxide reacts with hydrogen ions to produce copper ions and water (4H⁺+2CuO→2Cu⁺²+2H₂O). This compensates for copper depletion and acidification in the plating electrolyte. More generally, reaction of an oxide or hydroxide of the same oxidation state as the metal being electroplated (consider Cu⁺²/CuO, Ni⁺²/NiO, or Sn⁺²/SnO) replaces the generated acid with the metal ion and water and removes oxygen.

In some embodiments, a soluble positive ion having multiple oxidation states is employed to mitigate generation of hydrogen ions as the anode. Any number or possible soluble ion redox couples may be used. For example, ferrous ions (Fe⁺²) can be used. During operation, ferrous ions are oxidized to ferric ions (Fe⁺³) at the inert anode surface. In such embodiment, no gas is produced, and the electrolyte pH remains relatively unchanged as no oxygen gas or hydrogen ions are generated. However, without mitigation, the concentration of Fe⁺³ ions will increase over time. This can be addressed by either dosing a solution with known concentrations of ferrous ion (e.g., bleed and feed) as described above, or by driving a reverse electrochemical reaction (2Fe⁺³+Cu→2Fe⁺²+Cu⁺²) in an electrochemical cell containing the main electroplating electrolyte 1375. This can be done as either part of a recirculation loop or by removing the electrolyte to a separate apparatus and periodically or continuously returning the electrolyte to a main reservoir.

Bubble generation from generated oxygen can be mitigated by employing a non-oxygen saturated electrolyte. Such electrolyte may be flowed near the inert anode. Dissolved oxygen may be removed from the electrolyte by, e.g., using a contactor/membrane degasser in a flow loop that is connected to a vacuum and removes dissolved gases from the solution.

### Separation Gap Between the Electroplating Head and the Substrate

In certain embodiments, through resist electroplating using a patterned electrically resistive anode is implemented such that the head does not contact the substrate surface during electroplating within the electroplating cell. More specifically, the anode does not contact the top of the mask on the substrate surface. In certain embodiments, the anode's surface is separated from a substantially parallel surface of the substrate by a gap of about 0.1 to 2 millimeters. It is challenging to mechanically keep a small uniform gap over the full 300 mm of a workpiece surface.

A high electrolyte flow rate through the gap, which is needed to create good sheer and high-rate deposition, becomes hindered by the smaller channel and rapidly increasing pressure. At smaller gaps, sealing the part while rotating is difficult. In contrast, for the patterned electrically resistive anode application, being closer to the surface will give better proximity focusing and anode to substrate feature “throwing power,” so better uniformity correction capability.

### Through Resist Electroplating

In embodiments that employ through mask electroplating, a process creates and patterns a mask material, electrodeposits metal in features of the photoresist, and finally removes the mask material. The unit operations may include spin on coating, baking, lithographic patterning, descum/ashing, and mask stripping.

In some embodiments, a through mask electroplating process start by coating a substrate (e.g., a semiconductor substrate having a planar exposed surface) with a thin conductive seed layer material (e.g., Cu). The substrate may be a partially fabricated semiconductor substrate having patterned features in one or more dies. Next, the process forms a non-conductive mask layer, such as a photoresist, over the conductive seed layer. Thereafter, the process patterns the mask layer to define recessed features (e.g., round or polygonal holes) and then, in the case of photoresist masks, develops the mask layer. The recessed features define selective spaces where metal will be subsequently deposited.

Next, the process electroplates metal in regions of the substrate defined by the patterned photoresist. Finally, the process may strip the photoresist or other mask material from the substrate and optionally removes portions of the conductive seed layer.

Both the template layer of the patterned electrically resistive anode and the mask on the substrate may have patterns set by the pattern of metal to be electroplated onto the substrate. Both layers may have features that collectively map to the layout or pattern of the structure that is to be printed onto a substrate such as a semiconductor wafer. Examples of structures that map to the pattern of conductive material to be deposited on the substrate include wafer level packaging (WLP) patterns.

In various implementations, a different template layer as well as a different substrate mask layer pattern are required for each application. That is, a template layer, as well as a substrate mask layer, for a given application has a fixed pattern.

FIG. 7C schematically illustrates a resistive anode electroplating cell 741 performing through mask electroplating. As illustrated, cell 741 contains an electrolyte 743 containing dissolved metal ions (M) such as copper ions. Cell 741 also includes patterned electrically resistive anode 747 comprising a conductive layer 748, a resistive layer 749, and a non-conductive template layer 751. Embedded in recesses of template layer 751 are micro-anodes 461. An electrical lead 753 is connected to conductive layer 748. During electroplating, lead 748 applies an anodic current and/or potential to conductive layer 748.

Cell 741 also includes a substrate 755 with a patterned resist 757 disposed thereon. As depicted, during electroplating, a metal 759 is deposited within recesses of the patterned resist 757. The metal 759 may be produced by oxidizing metal ions M within exposed portions of substrate 755.

### Platform

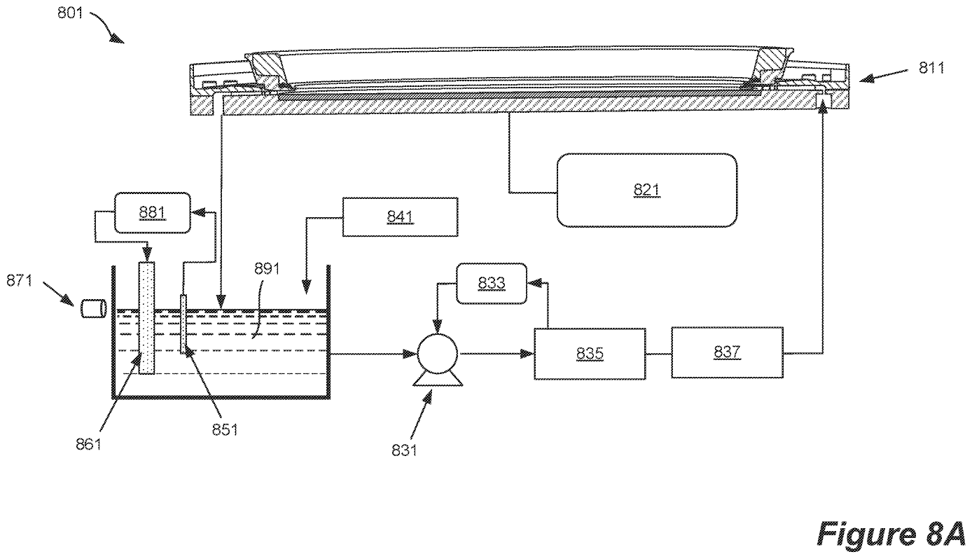

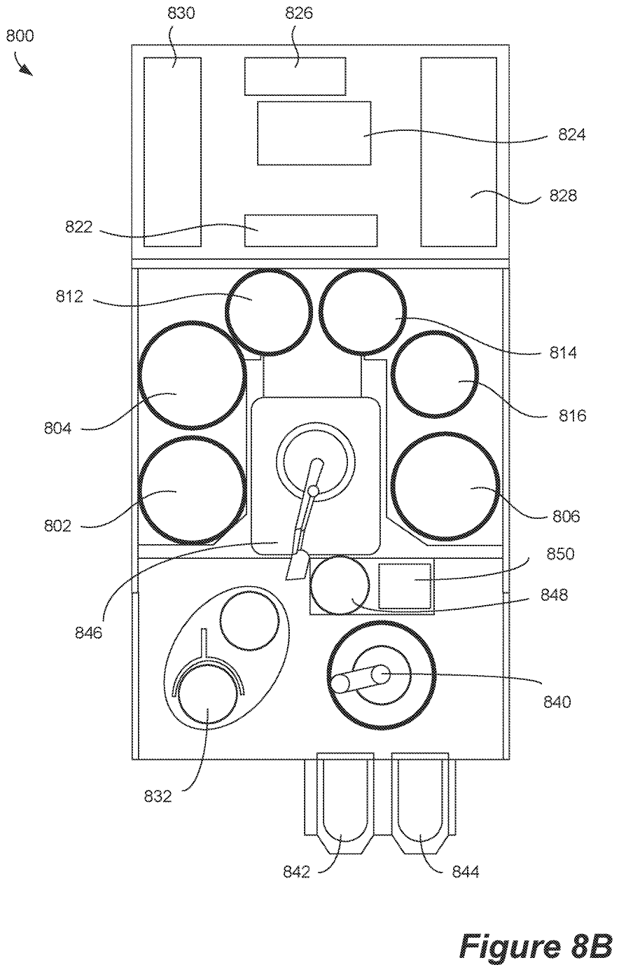

FIG. 8A illustrates a schematic diagram of an example print head electroplating cell in combination with general electroplating cell fluidic and plating controls according to some implementations. A print head electroplating cell 811 optionally includes an assembly with an elastomeric seal and one or more electrical contact members. The assembly serves to hold the substrate at its periphery and provide electrical current to the substrate. The inert anode array electroplating cell 811 further includes a print head adjacent to the substrate, where the print head and the substrate is separated by a small adjustable gap. A plurality of straightening fins may be positioned around the substrate (not directly under the substrate), where the plurality of straightening fins can have a height defined by the small gap. When electrolyte fluid comes up from an injection manifold, electrolyte fluid turns 90 degrees to provide a lateral flow over the surface of the print head. This occurs with the assistance of the straightening fins.

In some embodiments, the print head electroplating cell 811 is fluidly coupled to a plating solution reservoir 891 by inlet and outlet plumbing lines to create a circulatory flow loop. An electroplating system 801 includes the print head electroplating cell 811 and the plating solution reservoir 891. The electroplating system 801 may further include a recirculation pump 831, a flow meter 835, a degasser 837, cell and reservoir level monitors such as a level sensor 871, heat exchangers and/or immersion heaters 861, thermocouple 851, temperature controller 881 coupled to the thermocouple 851 and heat exchangers and/or immersion heaters 861, and one or more exhaust ports (e.g., side outlets). In some embodiments, the electroplating system 801 further includes density, pH, and/or conductivity meters, where such meters may be utilized for bath maintenance 841. In addition to the aforementioned hardware components, the electroplating system 801 may further include controllers such as a flow controller 833 for modifying and controlling the flow, temperature, chemical dosing of additives, acids, bases, etc. of the electrolyte fluid, and/or a controller 821. A power supply may be electrically coupled to the controller 821 for supplying current to the print head, a secondary electrode, and/or a substrate. A controller may be configured with instructions or programmed to control one or more of the processes described herein. Such processes may be related to flow direction, timing, substrate rotation, substrate and die layout identification, and current distribution control to the micro inert anode array. In some embodiments, an electrochemical metal cation regeneration system is housed within or fluidly coupled to the plating solution reservoir.

The two operation procedures described herein may be performed by any suitable system or platform, which may include one or more electroplating chambers. A suitable apparatus includes hardware for accomplishing the process operations and a system controller having instructions for controlling process operations in accordance with the present embodiments. For example, in some embodiments, the hardware may include one or more process stations included in a process tool.

FIG. 8B depicts a simplified view of a multi-tool electroplating apparatus according to some implementations. In the depicted embodiment, the electrodeposition apparatus 800 includes three separate electroplating modules 802, 804, and 806. The depicted apparatus 800 also includes three separate modules 812, 814, and 816 configured for various process operations. For example, in some embodiments, one or more of modules 812, 814, and 816 may be a spin rinse drying (SRD) module. In other embodiments, one or more of the modules 812, 814, and 816 may be post-electrofill modules (PEMs), each configured to perform a function, such as backside etching, and acid cleaning of substrates after they have been processed by one of the electroplating modules 802, 804, and 806.

The electrodeposition apparatus 800 includes a central electrodeposition chamber 824. The central electrodeposition chamber 824 is a chamber that holds the chemical solution used as the electroplating solution in the electroplating modules 802, 804, and 806. The electrodeposition apparatus 800 also includes a dosing system 826 that may store and deliver additives for the electroplating solution. A chemical dilution module 822 may store and mix chemicals to be used as an etchant. A filtration and pumping unit 828 may filter the electroplating solution for the central electrodeposition chamber 824 and pump it to the electroplating modules.

A system controller 830 provides electronic and interface controls required to operate the electrodeposition apparatus 800. The system controller 830 (which may include one or more physical or logical controllers) controls some or all of the properties of the electroplating apparatus 800.

Signals for monitoring the process may be provided by analog and/or digital input connections of the system controller 830 from various process tool sensors. The signals for controlling the process may be output on the analog and digital output connections of the process tool. Non-limiting examples of process tool sensors that may be monitored include mass flow controllers, pressure sensors (such as manometers), thermocouples, optical position sensors, etc. Appropriately programmed feedback and control algorithms may be used with data from these sensors to maintain process conditions.

A hand-off tool 840 may select a substrate from a substrate cassette such as the cassette 842 or the cassette 844. The cassettes 842 or 844 may be front opening unified pods (FOUPs). A FOUP is an enclosure designed to hold substrates securely and safely in a controlled environment and to allow the substrates to be removed for processing or measurement by tools equipped with appropriate load ports and robotic handling systems. The hand-off tool 840 may hold the substrate using a vacuum attachment or some other attaching mechanism. another mechanism may be responsible for moving a print head into or out of one or more of the electroplating modules 802, 804, and 806.

The hand-off tool 840 may interface with a wafer handling station 832, the cassettes 842 or 844, a transfer station 850, or an aligner 848. From the transfer station 850, a hand-off tool 846 may gain access to the substrate. The transfer station 850 may be a slot or a position from and to which hand-off tools 840 and 846 may pass substrates without going through the aligner 848. In some embodiments, however, to ensure that a substrate is properly aligned on the hand-off tool 846 for precision delivery to an electroplating module, the hand-off tool 846 may align the substrate with an aligner 848. The hand-off tool 846 may also deliver a substrate to one of the electroplating modules 802, 804, or 806 or to one of the three separate modules 812, 814, and 816 configured for various process operations.

An example of a process operation according to the methods described above may proceed as follows: (1) receiving a substrate in an electroplating module, where the substrate includes one or more dies having a non-uniform distribution of features; (2) contacting the substrate with an electrolyte in the electroplating module and a print head; and (3) electroplating metal on the substrate using the print head. In some embodiments, the print head contacts the substrate during printing onto the substrate. However, as explained, when electroplating into the print head, the print head is separated from the substrate by a defined gap. In some embodiments, contacting the print head with the electrolyte during the first operation includes cross-flowing the electrolyte laterally across the surface of the substrate.

An apparatus configured to allow efficient cycling of substrates through sequential plating, rinsing, drying, and PEM process operations may be useful for implementations for use in a manufacturing environment. To accomplish this, the module 812 can be configured as a spin rinse dryer and an edge bevel removal chamber. With such a module 812, the substrate would only need to be transported between the electroplating module 804 and the module 812 for the copper plating and EBR operations. In some embodiments the methods described herein will be implemented in a system which comprises an electroplating apparatus and a stepper.

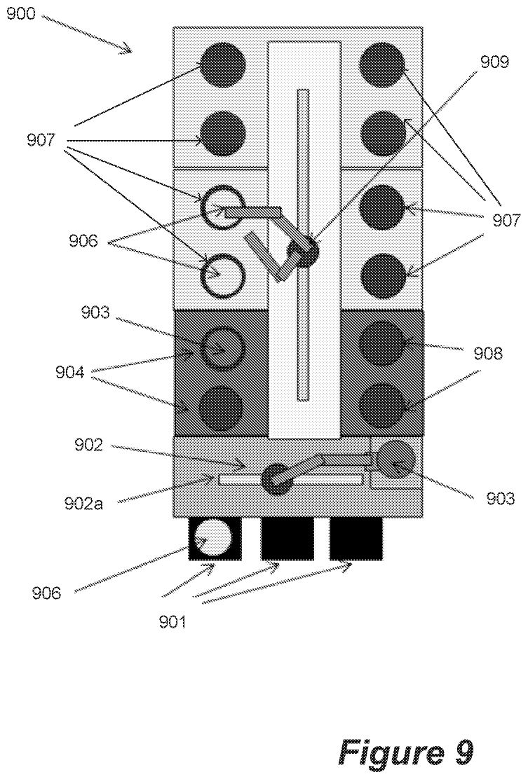

FIG. 9 depicts a simplified view of an example electroplating apparatus with different electroplating cells and modules according to some embodiments. In this embodiment, the electrodeposition apparatus 900 has a set of electroplating cells 907, each containing an electroplating bath, in a paired or multiple “duet” configuration. In addition to electroplating per se, the electrodeposition apparatus 900 may perform a variety of other electroplating related processes and sub-steps, such as spin-rinsing, spin-drying, metal and silicon wet etching, electroless deposition, pre-wetting and pre-chemical treating, reducing, annealing, electro-etching and/or electropolishing, photoresist stripping, and surface pre-activation with a pre-accelerator solution, for example. The electrodeposition apparatus 900 is shown schematically looking top down in FIG. 9, and only a single level or “floor” is revealed in the figure, but it is to be readily understood by one having ordinary skill in the art that such an apparatus, e.g., the Lam Sabre™ 3D tool, can have two or more levels “stacked” on top of each other, each potentially having identical or different types of processing stations.

Referring once again to FIG. 9, the substrates 906 that are to be electroplated are generally fed to the electrodeposition apparatus 900 through a front end loading FOUP 901 and, in this example, are brought from the FOUP to the main substrate processing area of the electrodeposition apparatus 900 via a front-end robot 902 that can retract and move a substrate 906 driven by a spindle 903 in multiple dimensions from one station to another of the accessible stations-two front-end accessible stations 904 and also two front-end accessible stations 908 are shown in this example. The front-end accessible stations 904 and 908 may include, for example, pre-treatment stations, and spin rinse drying (SRD) stations. Lateral movement from side-to-side of the front-end robot 902 is accomplished utilizing robot track 902a. Each of the substrates 906 may be held by a cup/cone assembly (not shown) driven by a spindle 903 connected to a motor (not shown), and the motor may be attached to a mounting bracket 909. Also shown in this example are the four “duets” of electroplating cells 907, for a total of eight electroplating cells 907. A system controller (not shown) may be coupled to the electrodeposition apparatus 900 to control some or all of the properties of the electrodeposition apparatus 900. The system controller may be programmed or otherwise configured to execute instructions according to processes described earlier herein.

In some implementations, a controller is part of a system, which may be part of the above-described examples. Such systems can comprise semiconductor processing equipment, including a processing tool or tools, chamber or chambers, a platform or platforms for processing, and/or specific processing components (a wafer pedestal, a gas flow system, etc.). These systems may be integrated with electronics for controlling their operation before, during, and after processing of a semiconductor wafer or substrate. The electronics may be referred to as the “controller,” which may control various components or subparts of the system or systems. The controller, depending on the processing requirements and/or the type of system, may be programmed to control any of the processes disclosed herein, including the delivery of processing gases, temperature settings (e.g., heating and/or cooling), pressure settings, vacuum settings, power settings, radio frequency (RF) generator settings, RF matching circuit settings, frequency settings, flow rate settings, fluid delivery settings, positional and operation settings, wafer transfers into and out of a tool and other transfer tools and/or load locks connected to or interfaced with a specific system.

Broadly speaking, the controller may be defined as electronics having various integrated circuits, logic, memory, and/or software that receive instructions, issue instructions, control operation, enable cleaning operations, enable endpoint measurements, and the like. The integrated circuits may include chips in the form of firmware that store program instructions, digital signal processors (DSPs), chips defined as application specific integrated circuits (ASICs), and/or one or more microprocessors, or microcontrollers that execute program instructions (e.g., software). Program instructions may be instructions communicated to the controller in the form of various individual settings (or program files), defining operational parameters for carrying out a particular process on or for a semiconductor wafer or to a system. The operational parameters may, in some embodiments, be part of a recipe defined by process engineers to accomplish one or more processing steps during the fabrication of one or more layers, materials, metals, oxides, silicon, silicon dioxide, surfaces, circuits, and/or dice of a wafer.

The controller, in some implementations, may be a part of or coupled to a computer that is integrated with, coupled to the system, otherwise networked to the system, or a combination thereof. For example, the controller may be in the “cloud” or all or a part of a fab host computer system, which can allow for remote access of the wafer processing. The computer may enable remote access to the system to monitor current progress of fabrication operations, examine a history of past fabrication operations, examine trends or performance metrics from a plurality of fabrication operations, to change parameters of current processing, to set processing steps to follow a current processing, or to start a new process. In some examples, a remote computer (e.g., a server) can provide process recipes to a system over a network, which may include a local network or the Internet. The remote computer may include a user interface that enables entry or programming of parameters and/or settings, which are then communicated to the system from the remote computer. In some examples, the controller receives instructions in the form of data, which specify parameters for each of the processing steps to be performed during one or more operations. The parameters may be specific to the type of process to be performed and the type of tool that the controller is configured to interface with or control. Thus, as described above, the controller may be distributed, such as by comprising one or more discrete controllers that are networked together and working towards a common purpose, such as the processes and controls described herein. An example of a distributed controller for such purposes would be one or more integrated circuits on a chamber in communication with one or more integrated circuits located remotely (such as at the platform level or as part of a remote computer) that combine to control a process on the chamber.

Without limitation, example systems may include a plasma etch chamber or module, a deposition chamber or module, a spin-rinse chamber or module, a metal plating chamber or module, a clean chamber or module, a bevel edge etch chamber or module, a physical vapor deposition (PVD) chamber or module, a chemical vapor deposition (CVD) chamber or module, an atomic layer deposition (ALD) chamber or module, an atomic layer etch (ALE) chamber or module, an ion implantation chamber or module, a track chamber or module, and any other semiconductor processing systems that may be associated or used in the fabrication and/or manufacturing of semiconductor wafers.

### Applications

Applications for the methods, apparatus, and systems herein include packaging technologies. Wafer level packaging, bumping, redistribution layers, fan out, and through-silicon vias (TSVs) are some types of advanced packaging. In many cases, integrated circuit packaging involves wafer level packaging (WLP), which is an electrical connection technology that employs relatively large features, typically on the scale of micrometers. Wafer-level packaging, as generally understood by those skilled in the art, refers to the technology of packaging an integrated circuit (IC) while it is still part of the wafer, in contrast to conventional methods of slicing a wafer into individual circuits (die) and then packaging them. Examples of WLP features include redistribution wiring, bumps, and pillars. Such features in WLP applications may be produced using the two operation procedures and apparatus described herein. Many of these applications are increasingly being perform on a much larger panel format and substrates, and it is understood that the invention described above is not limited in any way to the more prevalent high density packaging wafer format.

For certain applications, the features being printed have a diameter of at least about 2 μm or at least about 20 μm. For certain applications, the features being printed have a height of about least about 5 μm, or at least about 10 μm, or at least about 20 μm, or at least about 40 μm.

Though the present disclosure is mainly described in the context of WLP, it will be understood that the present disclosure is not limited to such applications. In some implementations, the present disclosure may be applied in non-WLP applications such as damascene applications or TSV applications. Damascene and TSV processes involve plating that occurs over the entire seeded and exposed surface of the substrate (no masking, but with recess metallized surfaces), and the feature patterns can still have variability in feature density that may be addressed with a print head of the present disclosure.

### CONCLUSION

In the foregoing description, numerous specific details are set forth to provide a thorough understanding of the presented embodiments. The disclosed embodiments may be practiced without some or all these specific details. In other instances, well-known process operations have not been described in detail to not unnecessarily obscure the disclosed embodiments. While the disclosed embodiments are described in conjunction with the specific embodiments, it will be understood that it is not intended to limit the disclosed embodiments.

Although the foregoing embodiments have been described in some detail for purposes of clarity of understanding, it will be apparent that certain changes and modifications may be practiced within the scope of the appended claims. It should be noted that there are many alternative ways of implementing the processes, systems, and apparatus of the present embodiments. Accordingly, the present embodiments are to be considered as illustrative and not restrictive, and the embodiments are not to be limited to the details given herein.

1. A print head comprising:
(a) a template layer comprising a non-conductive material having recesses or openings defining a pattern of conductive material to be printed on a substrate;
(b) a conductive layer overlaying the pattern of conductive material; and
(c) a resistive intermediate layer disposed between the template layer and the conductive layer.

2. The print head of claim 1, wherein the resistive layer has a conductivity of about 10⁻⁵ to 10⁻⁷ S/cm.

3. The print head of claim 2, wherein the resistive layer has a thickness of no greater than about 0.1 times the smallest pitch of the pattern of conductive material to be printed on a substrate.

4. The print head of claim 2, wherein the resistive layer has a thickness of about 0.1 to 10 micrometers.

5. The print head of claim 1, wherein the resistive layer comprises a carbon film.

6. The print head of claim 1, wherein the conductive layer has a sheet resistance of at most about 0.1 ohm/square.

7. The print head of claim 6, wherein the conductive layer has a thickness of about 0.01 to 10 micrometers.

8. The print head of claim 1, wherein the conductive layer comprises copper, nickel, cobalt, titanium, or any combination thereof.

9. The print head of claim 1, wherein the recesses or openings in the template layer have a thickness of about 5 to 300 micrometers.

10. The print head of claim 1, wherein the non-conductive material of the template layer comprises a glass, a polymer, a ceramic, or any combination thereof.

11. The print head of claim 1, wherein the pattern of conductive material to be printed on the substrate comprises a WLP pattern.

12. The print head of claim 11, wherein the WLP pattern is an RDL pattern

13. The print head of claim 11, wherein the WLP pattern is a pillar pattern.

14. The print head of claim 1, further comprising an electrically conductive contact to the conductive layer for applying an electrical potential from a power supply to the conductive layer.

15. The print head of claim 14, wherein the electrically conductive contact contacts a peripheral portion of the conductive layer.

16. The print head of claim 15, wherein the electrically conductive contact contacts the peripheral portion of the conductive layer at multiple points and is configured to provide substantially uniform current distribution around the peripheral portion of the conductive layer.

17. The print head of claim 1, wherein the template layer contacts the resistive intermediate layer, and the resistive intermediate layer contacts the conductive layer.

18. A method of printing features on substrate, the method comprising:
electroplating a metal into recesses of a print head, wherein the print head comprises (a) a template layer comprising a non-conductive material having the recesses or openings defining a pattern of the features to be printed on a substrate, (b) a conductive layer overlaying substantially the entire region of recesses or openings; and (c) a resistive intermediate layer disposed between the template layer and the conductive layer; and
electroplating the metal from the recesses of the print head template onto the substrate to print the features on the substrate.

19-26. (canceled)

27. An electroplating platform comprising:
a print head comprising recessed features defining a pattern to be printed a substrate;
a chamber comprising
a support configured to hold the substrate, and
a support configured to hold a secondary anode; and
a controller configured to cause:
electroplating a metal from the secondary anode into the recessed features of the print head, and
electroplating the metal from the recessed features of the print head onto the substrate.

28-40. (canceled)

41. A method of fabricating a print head, the method comprising:
forming a conductive layer having a substantially uniform thickness of a conductive material;
forming resistive intermediate layer over the conductive layer, wherein the resistive intermediate layer has a substantially uniform thickness of a resistive material; and
forming a template layer on the resistive intermediate layer, wherein the template layer comprises a non-conductive material having recesses or openings defining a pattern of conductive material to be printed on a substrate.

42-49. (canceled)

50. A patterned electrically resistive anode comprising:
(a) a template layer comprising a non-conductive material having recesses or openings defining a pattern of conductive material to be printed on a substrate,
(b) a plurality of micro anodes in the recesses or openings of the template layer;
(c) a conductive layer overlaying the pattern of conductive material; and
(d) a resistive intermediate layer disposed between the template layer and the conductive layer.

51-57. (canceled)

58. A method of depositing features on substrate, the method comprising:
in an electroplating cell, receiving the substrate with a mask layer on its surface, wherein the mask layer comprises recesses corresponding to a pattern of features to be electrodeposited on the substrate; and
electroplating a metal into the recesses of the mask layer by controlling a patterned electrically resistive anode comprising (a) a template layer comprising a non-conductive material and micro-anodes corresponding to the pattern of the features to be electrodeposited on the substrate, (b) a conductive layer overlaying the template layer; and (c) a resistive layer disposed between the template layer and the conductive layer.

59-62. (canceled)

63. An electroplating platform comprising:
an electroplating cell comprising a support configured to hold a substrate, and
a patterned electrically resistive anode comprising micro-anodes corresponding to a pattern of features to be deposited on the substrate; and
a controller configured to cause:
receiving in the electroplating cell the substrate with a mask layer on its surface, wherein the mask layer comprises recesses corresponding to the pattern of features to be deposited on the substrate; and
electroplating a metal into the recesses of the mask layer by controlling a patterned electrically resistive anode.

64-73. (canceled)
